(19) United States
(12) Patent Application Publication
(10) Pub. No.: US 2020/0319590 A1
(43) Pub. Date: Oct. 8, 2020

(54) Method for Producing a Volume Hologram Film Having Security Elements Formed as Transfer Sections

(71) Applicants: LEONHARD KURZ Stiftung & Co. KG, Furth (DE); OVD Kinegram AG, Zug (CH)

(72) Inventors: Norbert Lutz, Ruckersdorf (DE); Markus Burkhardt, Zirndorf (DE); Karin Forster, Rosstal (DE); Michael Scharfenberg, Nurnberg (DE); Andreas Schilling, Hagendorn (ZG) (CH)

(21) Appl. No.: 16/302,766

(22) PCT Filed: May 2, 2017
(86) PCT No.: PCT/EP2017/060426

§ 371 Date: Nov. 19, 2018

(30) Foreign Application Priority Data
May 25, 2016 (DE) 102016109633.4

(51) Int. Cl. G03H 1/00; G03H 1/02

(52) U.S. Cl. CPC G03H 1/0011; G03H 1/0256; G03H 1/0248; G03H 2250/33; G03H 2250/35; G03H 2250/34; G03H 2250/12

(57) ABSTRACT

A method for forming a volume hologram film having security elements which are formed as a transfer section of the volume hologram film is described, wherein the volume hologram film has n volume hologram layers arranged one over another. The production of the volume hologram film is carried out in a roll-to-roll method with the following method steps:
a) providing a carrier film from a supply roll;
b) applying an i-th photopolymer layer to the carrier film;
c) forming an i-th volume hologram in the photopolymer layer;
d) forming an i-th volume hologram layer by curing the i-th photopolymer layer;
e) repeating process steps b) to e) n−1 times;
f) applying an adhesive layer to the background layer;
g) winding the volume hologram film onto a take-up roll.

The invention relates to a method for producing a volume hologram film according to the subject of claim 1.

It is known from the state of the art, for producing a security element formed with several volume hologram layers arranged one over another which is provided for application to a security document, to produce the several volume hologram layers separately by coating and laser exposure and then to laminate these layers to each other.

US 2002/0174790 A1 describes a method for producing a security element having several volume hologram layers lying one over another, wherein the volume hologram layers are formed lying next to one another in an intermediate product, are separated from the intermediate product and then are laminated to form a multilayer body.

A disadvantage here is that the development of a high level of register accuracy of the volume hologram layers arranged one over another in the security element is possible only with a comparatively high outlay on technology.

The object of the present invention is to develop an improved method for producing a volume hologram film.

This object is achieved according to the invention with the subject of claim 1. A method for forming a volume hologram film having security elements which are formed as a transfer section of the volume hologram film is described, wherein the volume hologram film has n volume hologram layers arranged one over another, and wherein it is proposed that the production of the volume hologram film is carried out in a roll-to-roll method with the following method steps:

a) providing a carrier film from a supply roll;
b) applying an i-th photopolymer layer to the carrier film;
c) forming an i-th volume hologram in the photopolymer layer;
d) forming an i-th volume hologram layer by curing the i-th photopolymer layer;
e) repeating process steps b) to d) n−1 times.

The carrier film provided in method step a) can be a polyester film with a thickness in the range from 5 μm to 200 μm, preferably in the range from 10 μm to 30 μm.

In optional method steps arranged between method step a) and method step b) a detachment layer, which makes it easier to separate the carrier film from the finished security element, and a protective layer, which forms the uppermost layer in the finished security element, can be applied to the carrier film, as described further below.

The detachment layer can be applied to the carrier film in a first manufacturing station arranged downstream behind the supply roll. For this, the material which forms the detachment layer can be applied to the carrier film firstly in a coating device as a rule over the whole surface by printing, spraying or casting. The applied layer is dried and/or cured in a drying and/or curing device arranged downstream behind the coating device.

The protective layer can be applied to the detachment layer in a second manufacturing station arranged downstream behind the first manufacturing station. For this, the material which forms the protective layer is applied firstly in a coating device as a rule over the whole surface by printing, spraying or casting. The applied protective layer is dried and/or cured in a drying and/or curing device arranged downstream behind the coating device.

For the formation of the photopolymer layer in method step b) a photopolymer film is unwound from a supply roll, guided through between pressure rollers together with the carrier film and pressed onto the upper side of the carrier film or, if the carrier film has already been coated, onto the upper side of the layer lying on top. The photopolymer film is formed from a photopolymer which can be crosslinked under the action in particular of laser radiation and/or UV light and in the process can in particular change its optical refractive index. For example, volume holograms can be formed by crosslinking in areas, as described further below. The photopolymer film can have a thickness in the range from 3 μm to 100 μm. The photopolymer film can be designed as a self-supporting film made of photopolymer material, but also as a carrier film with a photopolymer layer that is not self-supporting applied thereto. It can also be provided, for the formation of the photopolymer layer, to apply photopolymer material to the upper side of the carrier film or, if the carrier film has already been coated, to the upper side of the layer lying on top over the whole surface or partially by printing, spraying or casting.

In method step c) the coated carrier film is fed to an exposure device arranged downstream behind the coating device. The exposure device can have a first exposure station, having a first laser and a first modulator, an optional second exposure station, having a second laser and a second modulator, as well as optional further exposure stations with further lasers and modulators, a volume hologram master as well as a UV light source.

For the recording of a volume hologram it can be provided to expose the photopolymer layer with coherent light of the first laser and optionally of the second laser and optional further lasers and then to irradiate it using the UV light source. During the recording, the coated carrier film is preferably in direct or indirect contact with the volume hologram master arranged under the carrier film. It can be provided here to design the volume hologram master as a flat volume hologram master, in particular on a plate, or as a curved volume hologram master, in particular on a lateral surface of a roller. The lasers and the modulators arranged in the beam path between the respective laser and the photopolymer layer and/or a deflection element determining the angle of incidence of the exposure beams are actuated correspondingly, with the result that the respective image area having a predetermined color value is exposed with a light with an exposure wavelength and/or with light striking at an angle which brings about a recording of a volume hologram image area with the predetermined color value and a predetermined range of angles of visibility. The incident exposure beams are superimposed with the exposure beams reflected by the volume hologram master. Through this interference of the exposure beams, so-called Bragg planes are formed in the image area within the photopolymer layer. These Bragg planes are local changes in the refractive index within the photopolymer layer which are optically active and thereby form the volume hologram.

Further, it is also possible to arrange exposure masks in the beam path between the lasers and the photopolymer layer, which determine the position and shaping of the image areas recorded by the respective laser.

In method step d) the exposed photopolymer layer is guided under the UV light source. In this way the photopolymer layer is converted into a first volume hologram layer.

It can be provided that the number n of volume hologram layers arranged one over another is two or more. Preferably, n is to be selected between 2 and 10, further preferably between 2 and 5.

As the proposed method is formed as a roll-to-roll method, adjustment steps, which are necessary for the register-accurate laminating of individually present volume hologram layers produced in separate process steps and other, in particular optically active, layers of a security element formed from laminated layers, are dispensed with. According to the invention the individual method steps are carried out inline here. Inline means here that there is no interruption of the process steps and/or there are no process steps decoupled from each other.

A further advantage of the proposed method is that all security elements transferred from the volume hologram film have the same register accuracy. A consistently high quality standard is thus achievable.

By register or registration, or register accuracy or registration accuracy, is meant a positional accuracy of two or more elements and/or layers relative to each other. The register accuracy here is to vary within a predetermined tolerance and to be as great as possible. At the same time, the register accuracy of several elements and/or layers relative to each other is an important feature in order to increase the process stability. The positionally accurate positioning can be effected here in particular by means of sensory, preferably optically detectable registration marks or register marks. These registration marks or register marks can either represent specific separate elements or areas or layers or themselves be part of the elements or areas or layers to be positioned.

It is particularly advantageous that, through the successive production of the multi-layered volume hologram film from which the security elements can be applied to the security document by transferring a transfer ply from a carrier film or by laminating, different exposure directions and/or different exposure wavelengths can be used and that different spatial directions in which the volume holograms can be observed and different motifs and/or designs and/or colors of the volume holograms can thereby be achieved.

Furthermore, it is thereby also possible to generate further volume holograms and optionally further layers with register accuracy or registration accuracy relative to preceding or following volume holograms and to match them with each other and arrange them one on another. In particular, the inline production described here without interposed winding up of the volume hologram film makes a particularly precise alignment of the individual layers relative to each other possible.

Alternatively, it is also possible to apply the different volume hologram layers “offline” by successive steps in one and the same device and thereby to generate the multi-layered volume hologram film. This means that after one pass the volume hologram film is wound up and correspondingly unwound again for a further pass in the same device. A registration of the layers relative to each other is also possible here, but the precision is lower than in the above-described advantageous inline production.

It can also be provided to apply the different volume hologram layers to the security document in several passes. Thus, it is possible for example to provide a semi-finished film product wound up on a supply roll in a first pass, from which different finished products can be produced in a further pass or in several further passes.

It can be provided that in method step b) the photopolymer layer is applied by pressing of a photopolymer film, wherein the photopolymer film is provided on a supply roll. The adhesion of the photopolymer film to the carrier film can be improved, for example, by pressing under the action of temperature.

Alternatively it can be provided that in method step b) the photopolymer layer is applied over the whole surface or partially by printing, spraying or casting.

It can be provided that in method step c) the formation of the i-th volume hologram is effected by a laser exposure, as described in detail further above.

It can further be provided that the i-th photopolymer layer is pre-cured between method step c) and method step d) and is finally cured in method step d). For the final curing the coated carrier film is fed to a curing device arranged downstream behind the exposure device, in order to achieve a complete hardening of the volume hologram layer. The curing device has a UV lamp.

In a further advantageous embodiment it can be provided that a background layer is applied to the n-th volume hologram layer. The background layer can be applied to the n-th volume hologram layer in a manufacturing station arranged downstream.

It can further be provided that an adhesive layer is applied to the background layer.

Alternatively it can be provided that an adhesive layer is applied to the n-th volume hologram layer.

During the application of a security element separated from the volume hologram film to a substrate, the adhesive layer forms the undermost layer of the security element formed as a multi-layer body.

In a final method step the volume hologram film can be wound onto a take-up roll.

The volume hologram film can be formed as a transfer film or as a laminating film.

It can be provided that, for the formation of the volume hologram film into a transfer film, the following further method steps are carried out before method step b):
applying a separating layer;
applying a protective layer.

The separating layer makes it easier to detach the security element from the carrier film. The protective layer forms the uppermost layer of the security element after the security element has been detached and protects it from environmental influences.

It can be provided that, for the formation of the volume hologram film into a laminating film, the following further method step is carried out before method step b):
applying an adhesion-promoter layer.

The photopolymer layer is then applied to the adhesion-promoter layer.

It can further be provided that an intermediate layer is applied to the photopolymer layer after method step b). The term intermediate layer is used here and in the following as an umbrella term for one or more layers which can be formed differently and can form different functions, as described below.

It can be provided that the intermediate layer is formed as a barrier layer or an adhesion-promoter layer.

It can also be provided that the intermediate layer is formed as a decorative layer.

It can further be provided that the intermediate layer is formed as a partial reflective layer.

It can be provided that further method steps are carried out before method step b):
applying a first and a second intermediate layer to the carrier film, wherein, for example, the first intermediate layer is formed as a protective layer and the second intermediate layer is formed as a replication layer;
molding a microstructure into the second intermediate layer;
applying a metallic layer to the microstructure;
applying a third intermediate layer.

When a detachment layer and/or a protective layer or an adhesion-promoter layer has or have already been applied to the carrier film, then the above-named intermediate layers are applied to the respectively uppermost layer of the coated carrier film.

It can be provided that the microstructure is formed as a blazed grating, a linear or crossed sinusoidal grating or an isotropic or anisotropic matte structure. Cross gratings, lens structures or combination structures of the above-named structures are further possible.

The following dependent claims are directed at the formation of the background layer. The background layer can be formed as one layer or as a multi-layer body formed of several layers. It can also be provided that the background layer is formed differently in areas.

It can be provided that the background layer has a color layer of color-constant pigments or colorants. The volume holograms arranged over the colored background layer in the case of an applied security element can thereby appear, for example, in an improved contrast, because the light reflection is reduced compared with a light, in particular a white, background layer. Further, the color impression of the volume hologram can be influenced by the color of the background layer arranged underneath it.

It can also be provided that the background layer has an optically variable color layer. An optically variable color layer, for example an optically variable ink (OVI) and/or a thin-film layer system and/or a liquid crystal system, shows different colors at different observation angles. This property can be used, for example, to form dramatic designs.

It can further be provided that the background layer has a thin-film element. While the thin-film element is perceived colored at all observation angles, wherein the color varies depending on the observation angle and/or illumination angle, the volume holograms of the volume hologram layers can be visible only in certain angle ranges. If the color of the thin-film element differs, at a certain observation angle, from the color of the respective volume hologram at this observation angle, then the color impression of the respective volume hologram is altered by the superimposition with the color of the thin-film element lying in the background.

The thin-film element can have a semi-transparent first reflective layer, a highly reflective second reflective layer and a transparent spacer layer arranged between the first reflective layer and the second reflective layer.

The spacer layer can be formed with a thickness in the range from 100 nm to 1000 nm.

It can further be provided that the background layer has a mask layer.

The mask layer can be formed as a metallic layer, which is formed over the whole surface or in areas, covered by an intermediate layer. After application of the security element to a security document the metallic layer can be arranged underneath the volume hologram layers and has the effect, firstly, that the surface of the security document is covered and thereby the volume holograms lying on top are not superimposed by the color and shape of any printing on the security document. Moreover, the visibility of the volume holograms can increase in particular observation situations and/or illumination situations, as the metallic layer becomes dark when the security document is tilted beyond the mirror reflex.

It can also be provided that the mask layer has a color layer formed in areas, a first intermediate layer, a metallic layer and an optional second intermediate layer. The intermediate layers can in each case be formed as a replication layer and/or barrier layer and/or seal layer and/or an adhesion-promoter layer and/or as a decorative layer and/or as a whole-surface or partial reflective layer.

In an advantageous embodiment of the above-described mask layer it can be provided that the first intermediate layer is formed as a replication layer, that a surface microstructure is molded into the first intermediate layer and that a metallic layer is applied to the surface microstructure.

The metallic layer can be formed over the whole surface or be formed only in partial areas. The metallic layer can be formed from aluminum, copper, gold, silver, chromium, tin or an alloy of these materials.

It can be provided that the metallic layer is formed with a thickness in the range from 0.1 nm to 1000 nm, preferably from 5 nm to 100 nm.

In a further advantageous embodiment it can be provided that the background layer has an absorption layer. The absorption layer can be formed over the whole surface, but also only in partial areas. The absorption layer can be formed, for example, as a non-tunable Fabry-Perot interferometer, which is formed, for example, from a semi-transparent metallic mirror layer, e.g. made of aluminum or silver, followed by a thin dielectric and transparent layer and a second mirror layer (multiple interference filter). The wavelength to be absorbed can be set by the choice of the layer thickness of the dielectric layer. After application of the security element to a security document the absorption layer can be arranged underneath the volume hologram layers and can have the effect, firstly, that the surface of the security document is covered and thereby, at least in areas, the volume holograms lying on top are not superimposed by the color and shape of any printing on the security document. Moreover the visibility of the volume holograms can increase, as the absorption layer absorbs the incident light at least in particular wavelength ranges.

The absorption layer can advantageously be formed as a dielectric filter. The dielectric filter can have, for example, four filter layers.

It can further be provided that the background layer has a fluorescent layer. The fluorescent layer can be formed over the whole surface or in areas. The fluorescent layer is formed, for example, of a varnish made of fluorescent organic and inorganic pigments dissolved in a thiophene-benzoaxol derivative. The fluorescent layer is applied using the usual printing methods, for example gravure printing, screen printing, flexographic printing, inkjet printing or using other coating methods, over the whole surface or partially in the decorative printing. The layer thickness is preferably between 0.1 μm and 6 μm after the drying. After application of the security element to a security document the fluorescent layer can be arranged underneath the volume hologram layers. While the fluorescent layer appears in shades of gray when irradiated with daylight, conditional on the intrinsic color of the fluorescent pigments, it lights up colored when irradiated with UV light (wavelengths of, for example, 365 nm or 254 nm). The volume holograms lying on top can thereby be more visible and/or the color impression of the volume holograms can be altered by the superimposition with the fluorescence.

It can also be provided that the background layer has a phosphorescent layer. The phosphorescent layer can be formed over the whole surface or in areas. The phosphorescent layer is applied using the usual printing methods, for example gravure printing, screen printing, flexographic printing, inkjet printing or using other coating methods, over the whole surface or partially in the decorative printing. After application of the security element to a security document the phosphorescent layer can be arranged underneath the volume hologram layers. While the phosphorescent layer appears in shades of gray when irradiated with daylight, conditional on the intrinsic color of the phosphorescent pigments, it lights up colored when irradiated with UV light. The volume holograms lying on top can thereby be more visible and/or the color impression of the volume holograms can be altered by the superimposition with the phosphorescence. This is of particular interest because the phosphorescent pigments, unlike fluorescent pigments, emit an afterglow for a particular time and thereby the better visibility and/or the altered color impression of the volume holograms is preserved for a particular time after the illumination with UV light.

In a further advantageous embodiment it can be provided that the background layer has a microstructure layer.

The microstructure layer can be formed as a replication layer, wherein a surface microstructure is molded into the replication layer and a metallic layer is applied to the surface microstructure.

The surface microstructure can be formed as a linear or crossed sinusoidal grating, as an asymmetrical blazed grating, as an isotropic or anisotropic matte structure or as a surface hologram. Cross gratings, lens structures or combination structures of the above-named are further possible. The metallic layer can be formed over the whole surface or be formed only in partial areas. The metallic layer can preferably consist of aluminum, copper, gold, silver, chromium or tin or an alloy of these materials and can have a thickness of from 0.1 nm to 1000 nm, preferably a thickness of from 5 nm to 100 nm. After application of the security element to a security document the microstructure layer can be arranged underneath the volume hologram layers and can have the effect, firstly, that the surface of the security document is covered and thereby the volume holograms lying on top are not superimposed by the color and shape of any printed image on the security document. Moreover, the visibility of the volume holograms can increase, as the metallic layer becomes dark when the security document is tilted beyond the mirror reflex. Depending on the design of the holograms used, the volume holograms formed in the volume hologram layers and a metallized surface hologram formed in the microstructure layer can be visible at the same observation angle or at different observation angles.

It can be provided that the surface microstructure is formed as a sinusoidal grating, with periods in a range from 0.2 μm to 10 μm, preferably in a range from 0.5 μm to 2.0 μm, and depths in a range from 30 nm to 5000 nm, preferably in a range from 100 nm to 300 nm.

It can also be provided that an HRI layer with a high refractive index is applied to the surface microstructure. The HRI layer can be applied instead of or in addition to the metallic layer. It is an in particular transparent layer with a high refractive index (HRI). The surface of the security document is not covered by the HRI layer and the volume holograms lying in particular over the HRI layer are superimposed by the color and shape (motif) of any printed image on the security document. Depending on the design of the holograms used, the volume holograms formed in the volume hologram layers and a surface hologram formed in the surface microstructure and provided with the HRI layer can be visible at the same observation angle and/or at different observation angles.

The security element that can be detached from the above-described volume hologram film can be transferred to a security document, which can be, for example, identity papers, a banknote, a bank card or another card document.

In the case of a security document formed as a banknote or identity document, for example, a first strip-shaped security element can be arranged on the upper side of the security document and a second security element can be arranged in a window of the security document. The first security element can also be formed as a patch not in the shape of a strip or as an overlay covering the security document largely over the whole surface.

The first security element is transferred from the volume hologram film described further above to the security document. If the volume hologram film is formed as a transfer film, the carrier film is detached from the transfer ply after application of the transfer ply to the security document. If the volume hologram film is formed, on the other hand, as a laminating film, then the carrier film remains on the security document after application as the uppermost layer of the security element.

The window can be formed, for example, as a transparent area of a polymer banknote or as a punched hole in a paper banknote. Furthermore, it can also be, e.g., a transparent area in an ID card, e.g. made of polycarbonate or the like. Visual features in the transparent areas of the security document can be formed differently and are divisible into three groups:
features which are visible in reflection, visible when the front side of the security document is observed;
features which are visible in reflection, visible when the rear side of the security document is observed;
features which are visible in transmission, i.e. when the security document is held in front of a light source.

In particular the combination of a feature which is visible in reflection with a feature which is visible only in transmission yields a surprise effect for the observer, as the conditions for the transmission feature are only rarely met, e.g. when a banknote is held against the light. Thus, this transmission feature is almost always invisible; only in transmission, observed against a light source, does an item of information appear (e.g. the denomination of the banknote). A combined item of information is a visually interesting feature which is at the same time very secure against forgery.

The invention is now explained in more detail with reference to embodiment examples. There are shown in:

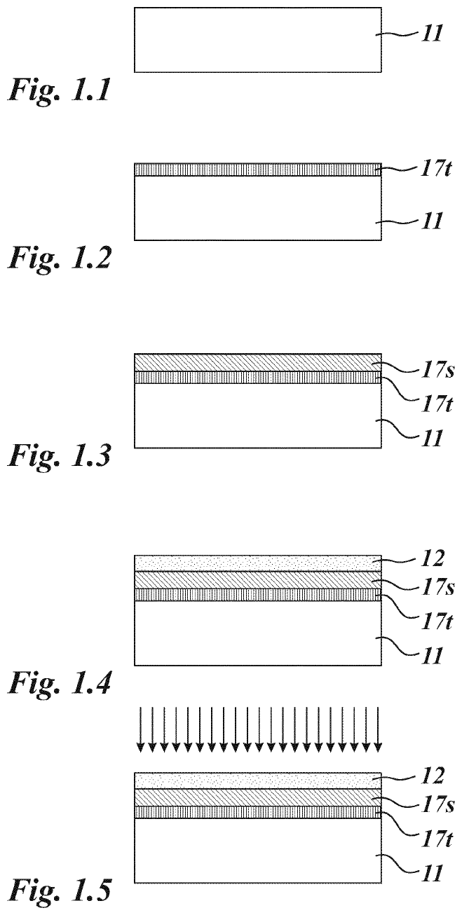

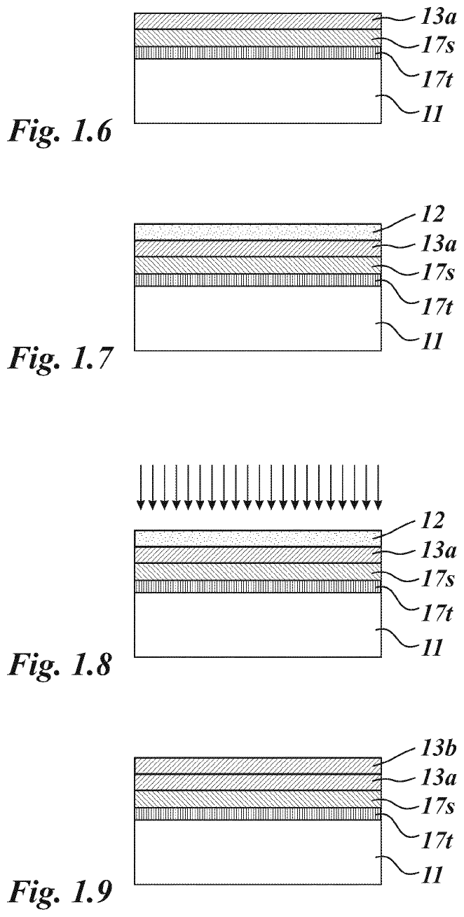

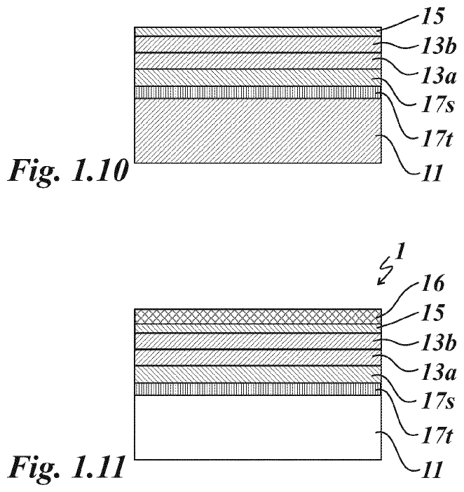

FIGS. 1.1 to 1.11 an embodiment example of the method according to the invention for forming a first embodiment example of a security element in schematic sectional representations;

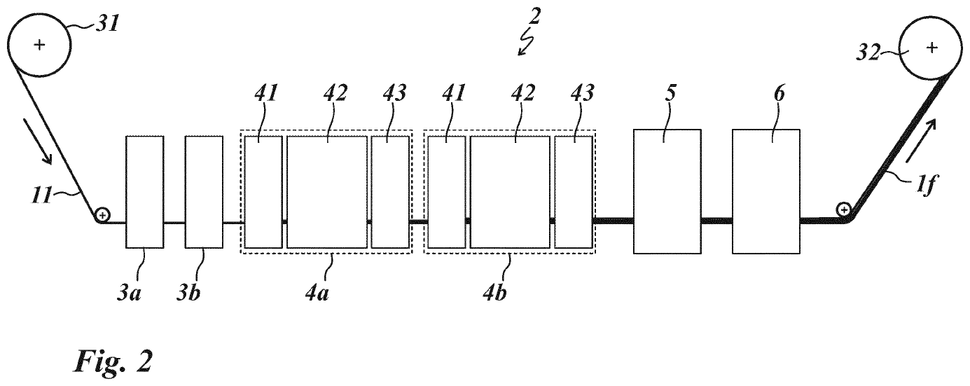

FIG. 2 a first embodiment example of a device for carrying out the method described in FIGS. 1.1 to 1.11 in a schematic representation;

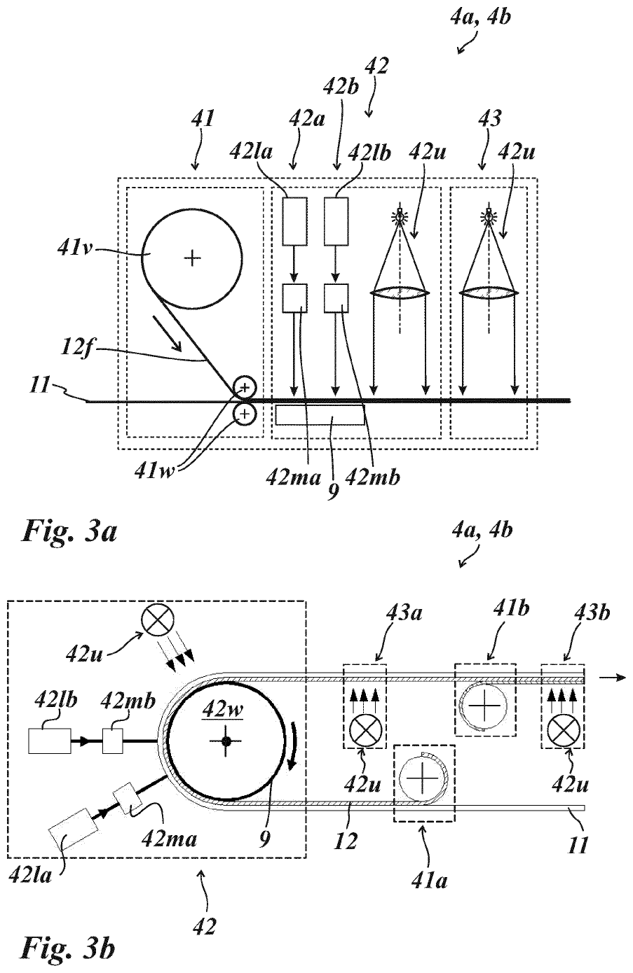

FIG. 3a a first embodiment example of a manufacturing station in FIG. 2 in a schematic representation;

FIG. 3b a second embodiment example of a manufacturing station in FIG. 2 in a schematic representation;

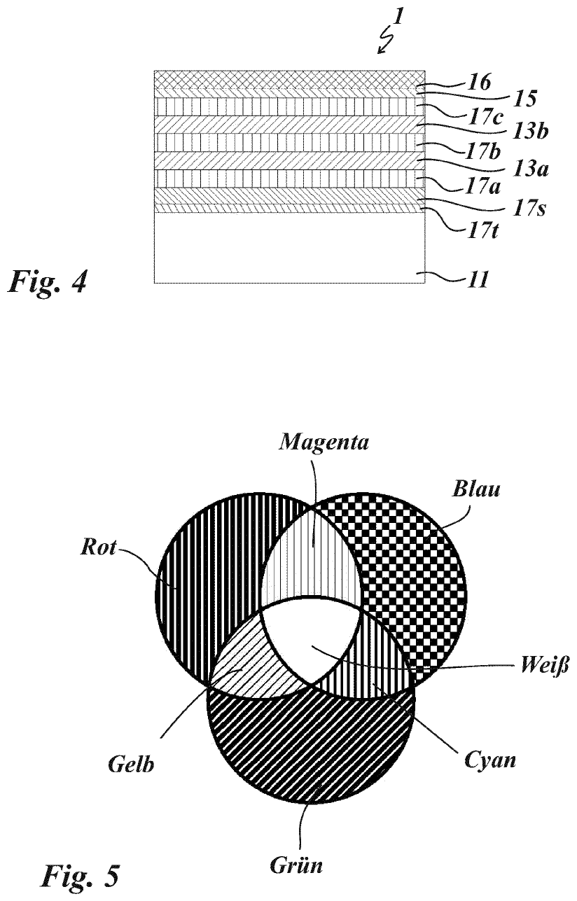

FIG. 4 a second embodiment example of the security element;

FIG. 5 the principle of the additive color mixing;

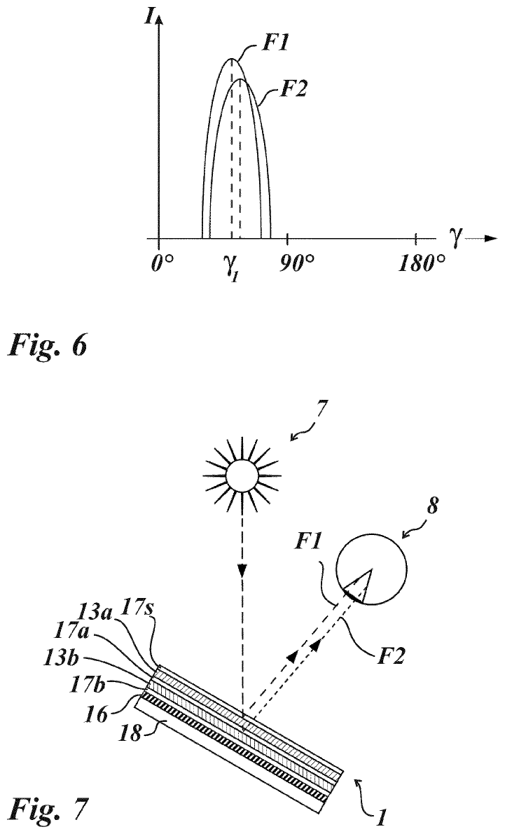

FIG. 6 a first schematic representation to illustrate at what angles a volume hologram is visible;

FIG. 7 a first schematic representation of the geometric conditions during observation of a volume hologram;

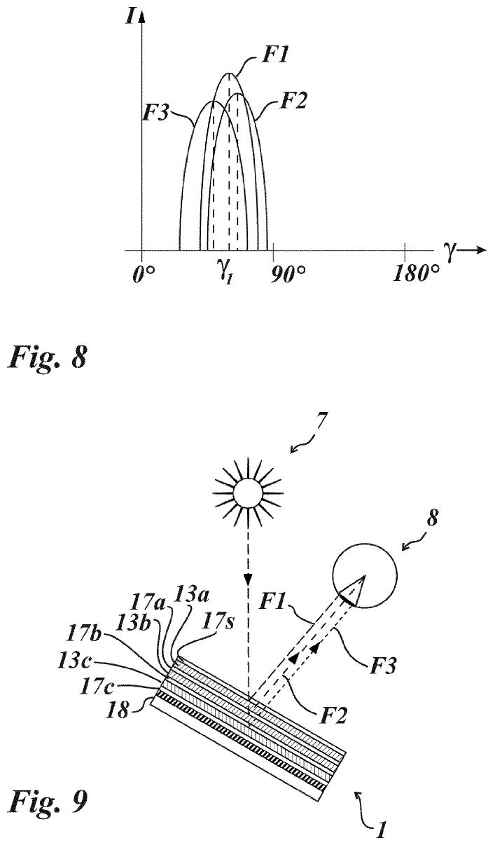

FIG. 8 a second schematic representation to illustrate at what angles a volume hologram is visible;

FIG. 9 a second schematic representation of the geometric conditions during observation of a volume hologram;

FIG. 10 a first embodiment example of a document formed with the security element;

FIG. 11 a second embodiment example of a document formed with the security element;

FIG. 12 a third embodiment example of a document formed with the security element;

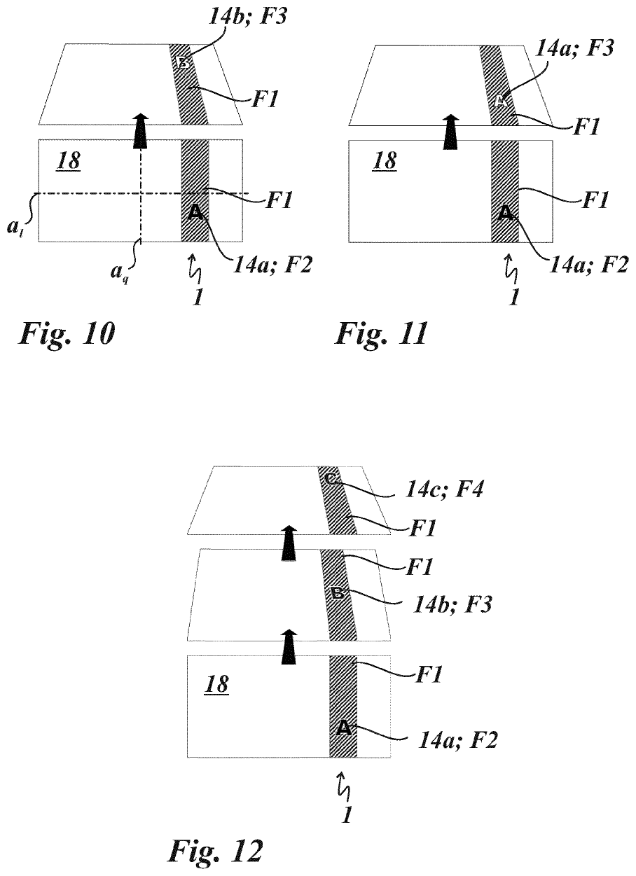

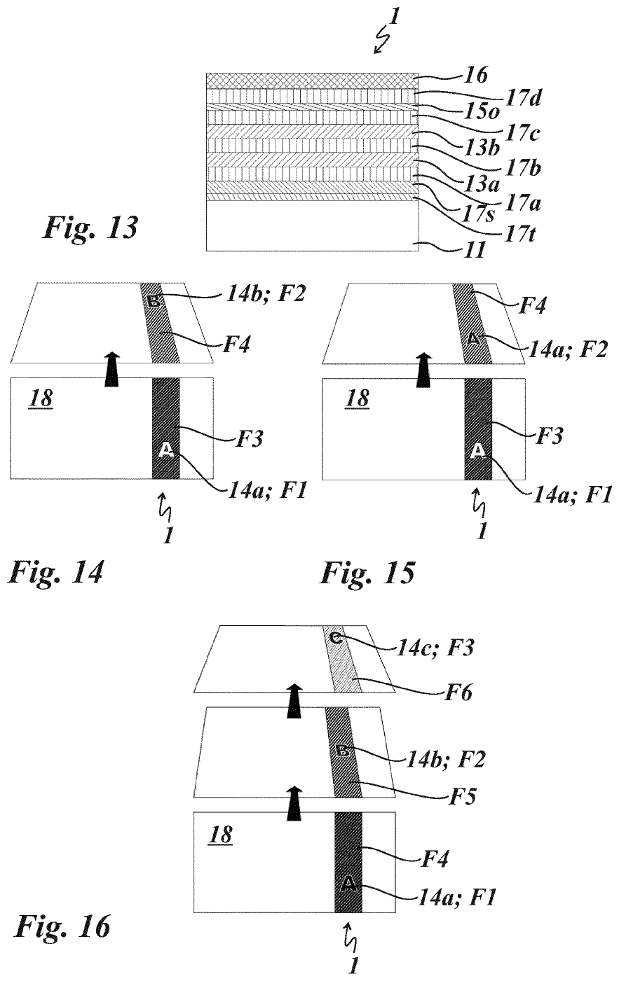

FIG. 13 a third embodiment example of the security element;

FIG. 14 a fourth embodiment example of a document formed with the security element;

FIG. 15 a fifth embodiment example of a document formed with the security element;

FIG. 16 a sixth embodiment example of a document formed with the security element;

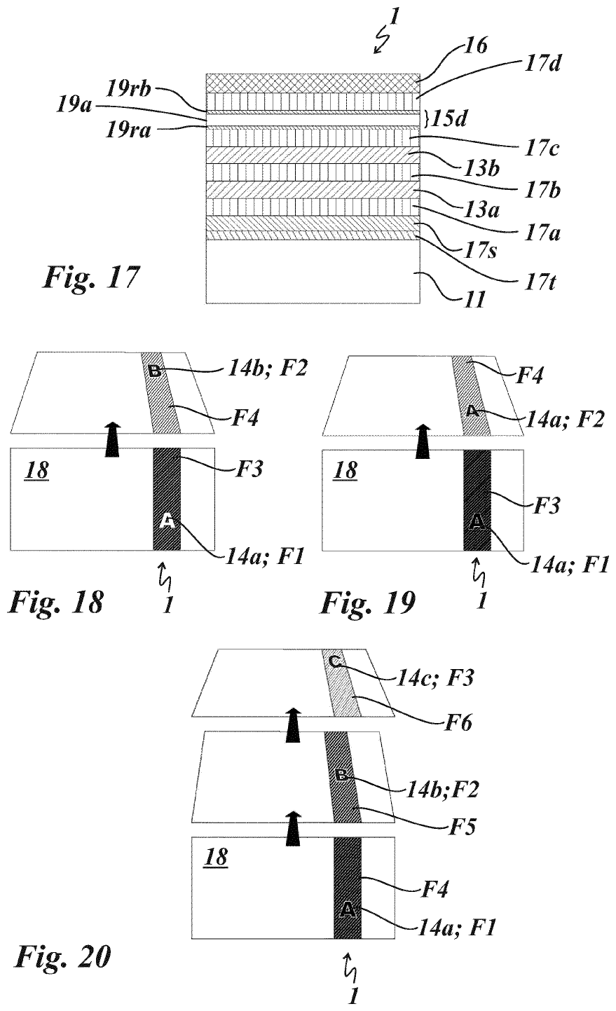

FIG. 17 a fourth embodiment example of the security element;

FIG. 18 a seventh embodiment example of a document formed with the security element;

FIG. 19 an eighth embodiment example of a document formed with the security element;

FIG. 20 a ninth embodiment example of a document formed with the security element;

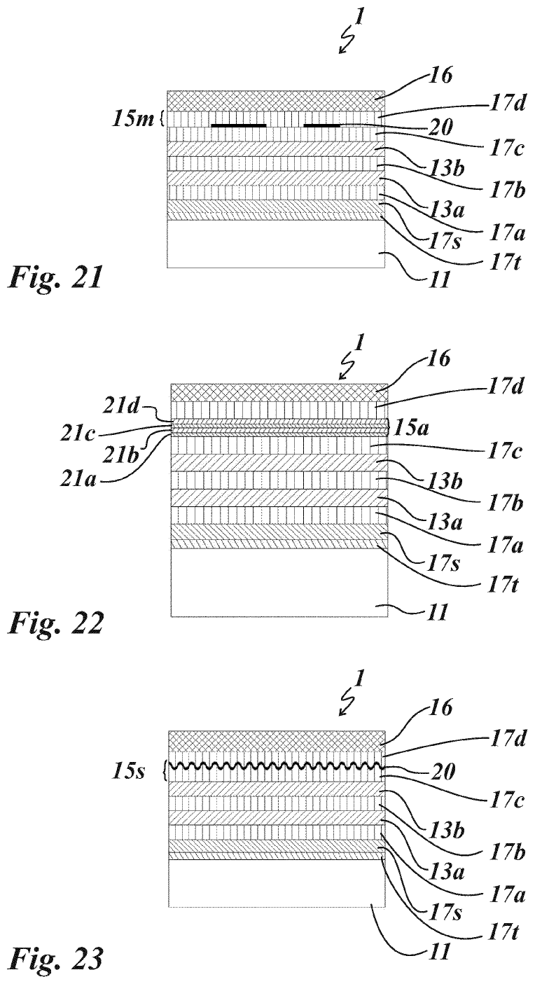

FIG. 21 a fifth embodiment example of the security element;

FIG. 22 a sixth embodiment example of the security element;

FIG. 23 a seventh embodiment example of the security element;

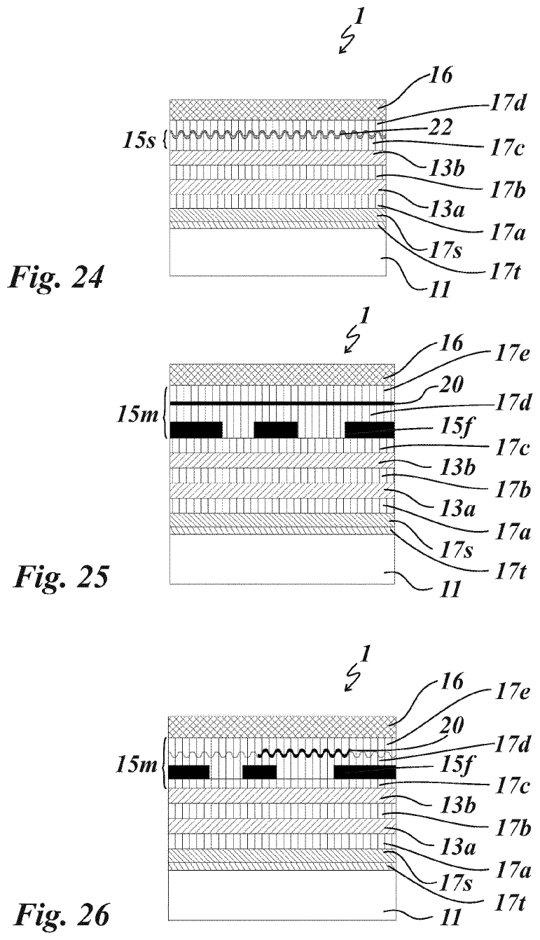

FIG. 24 an eighth embodiment example of the security element;

FIG. 25 a ninth embodiment example of the security element;

FIG. 26 a tenth embodiment example of the security element;

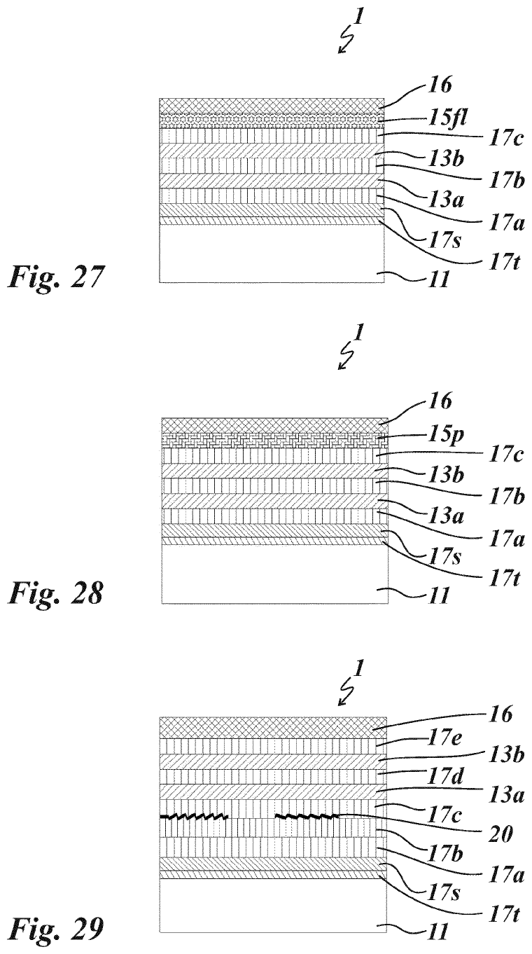

FIG. 27 an eleventh embodiment example of the security element;

FIG. 28 a twelfth embodiment example of the security element;

FIG. 29 a thirteenth embodiment example of the security element;

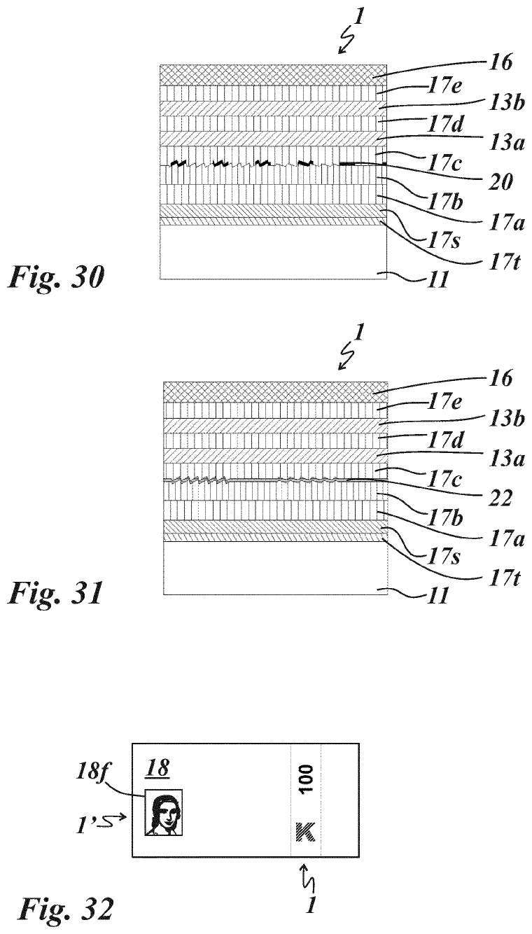

FIG. 30 a fourteenth embodiment example of the security element;

FIG. 31 a fifteenth embodiment example of the security element;

FIG. 32 a tenth embodiment example of a document formed with the security element;

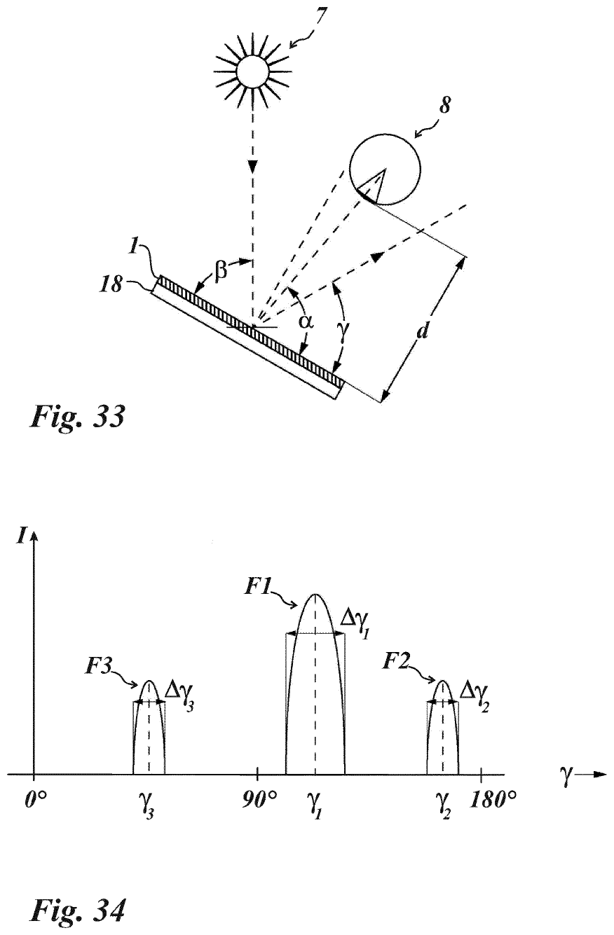

FIG. 33 a third schematic representation of the geometric conditions during observation of a volume hologram;

FIG. 34 a third schematic representation to illustrate at what angles a volume hologram is visible;

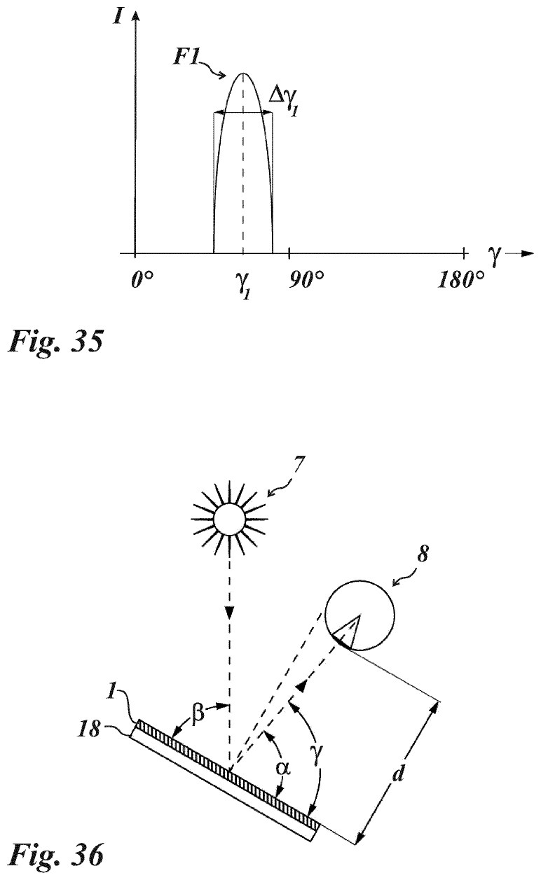

FIG. 35 a fourth schematic representation to illustrate at what angles a volume hologram is visible;

FIG. 36 a fourth schematic representation of the geometric conditions during observation of a volume hologram;

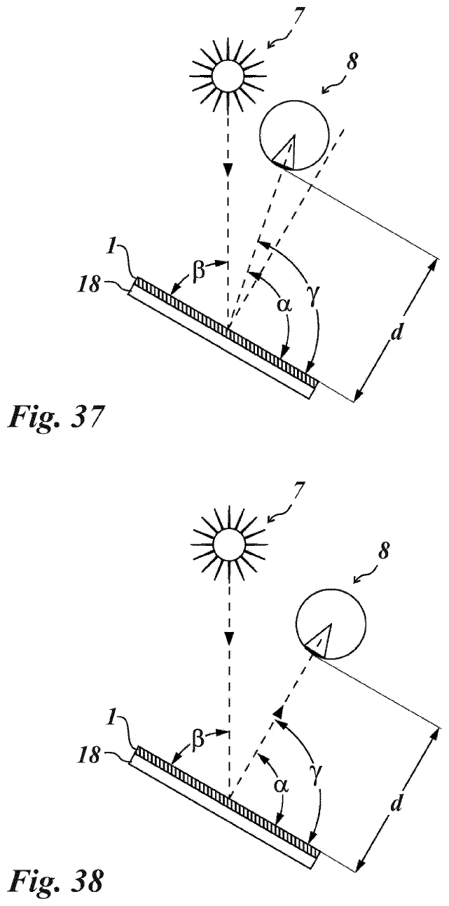

FIG. 37 a fifth schematic representation of the geometric conditions during observation of a volume hologram;

FIG. 38 a sixth schematic representation of the geometric conditions during observation of a volume hologram;

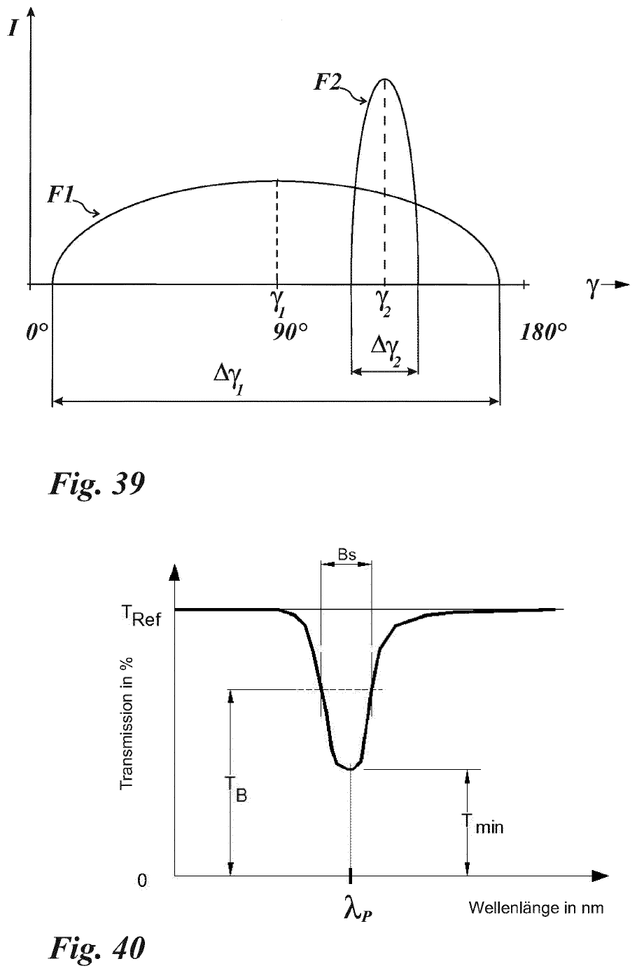

FIG. 39 a fifth schematic representation to illustrate at what angles a volume hologram is visible;

FIG. 40 a schematic representation of a transmission spectrum;

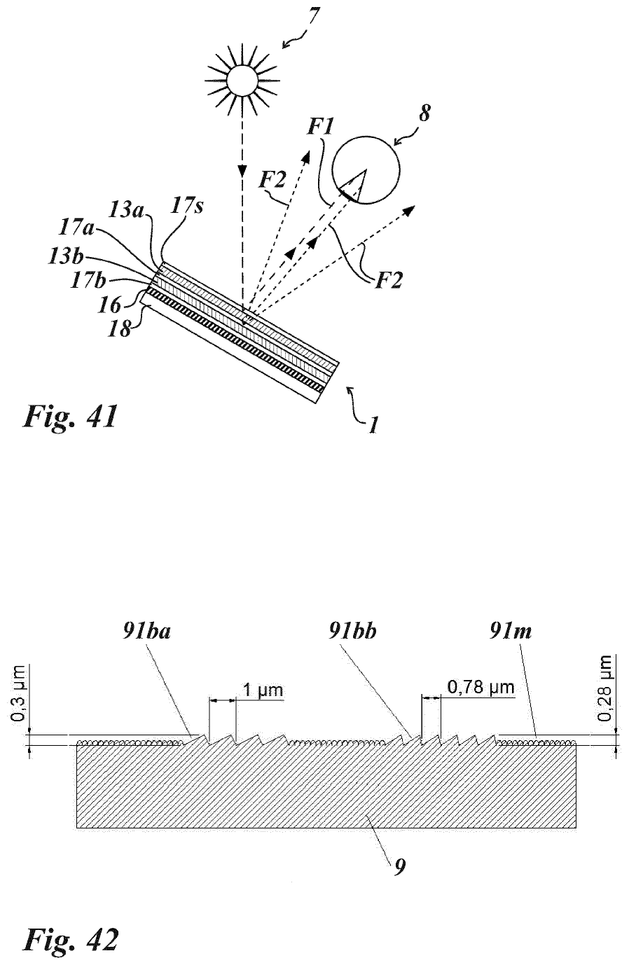

FIG. 41 a seventh schematic representation of the geometric conditions during observation of a volume hologram;

FIG. 42 an embodiment example of a surface relief master in a schematic sectional representation;

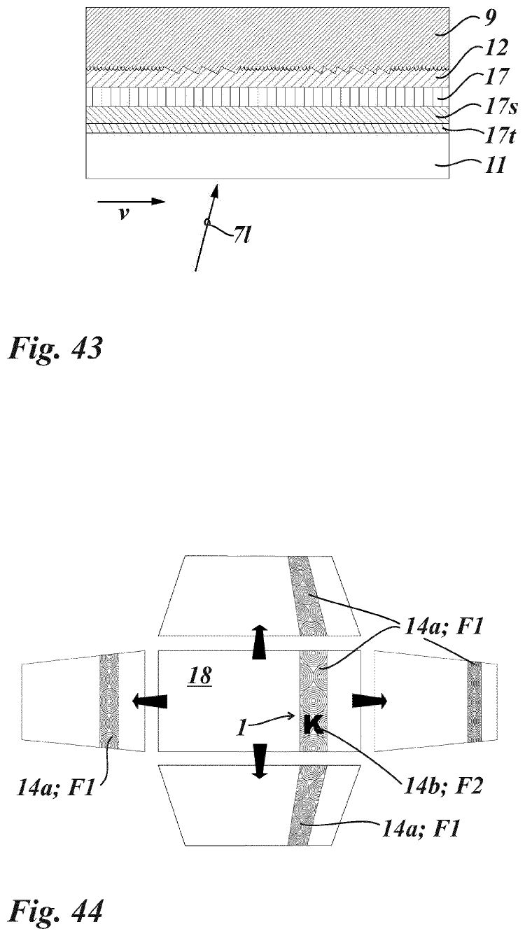

FIG. 43 the principle of the volume hologram production;

FIG. 44 an eleventh embodiment example of a document formed with the security element;

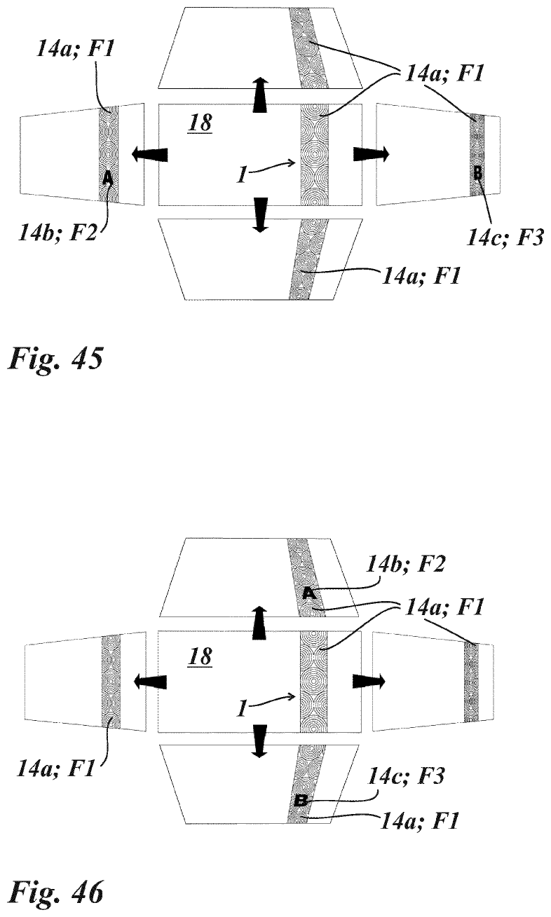

FIG. 45 a twelfth embodiment example of a document formed with the security element;

FIG. 46 a thirteenth embodiment example of a document formed with the security element;

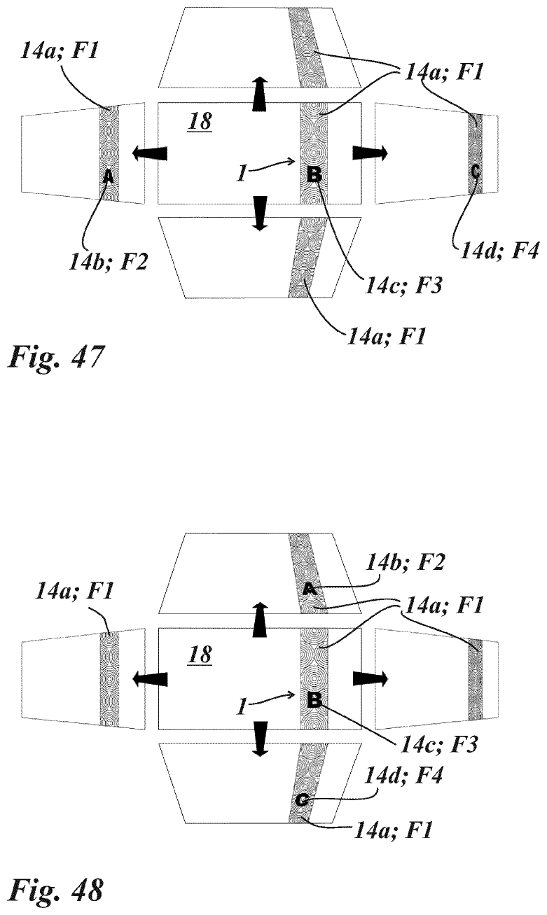

FIG. 47 a fourteenth embodiment example of a document formed with the security element;

FIG. 48 a fifteenth embodiment example of a document formed with the security element;

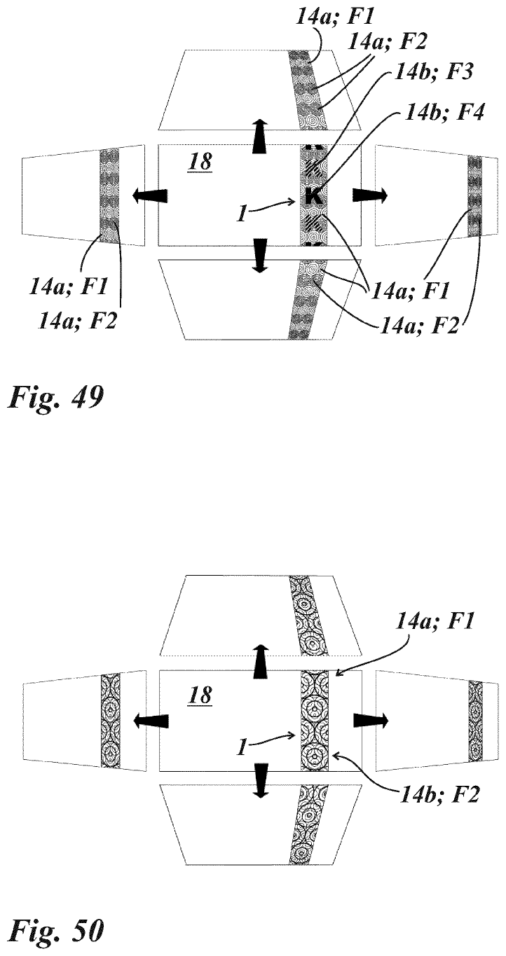

FIG. 49 a sixteenth embodiment example of a document formed with the security element;

FIG. 50 a seventeenth embodiment example of a document formed with the security element;

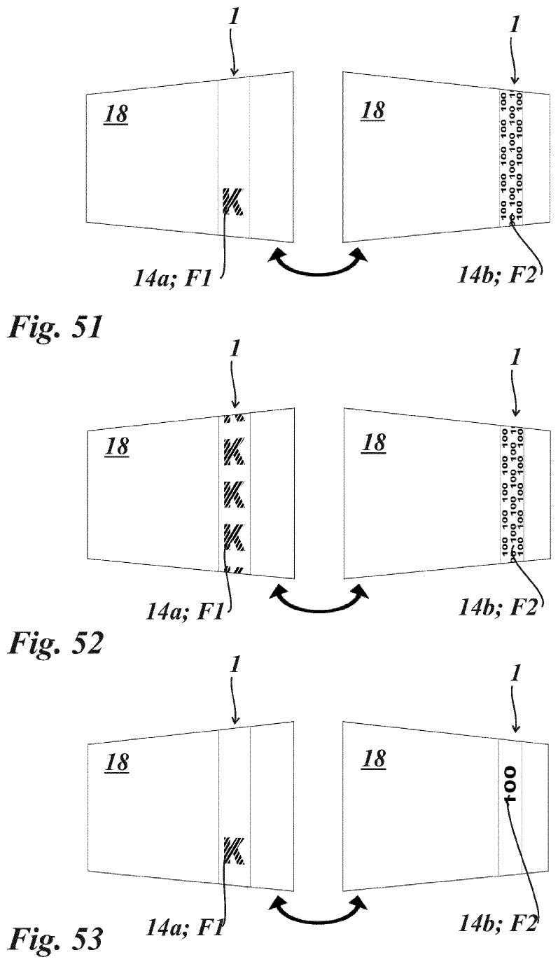

FIG. 51 an eighteenth embodiment example of a document formed with the security element;

FIG. 52 a nineteenth embodiment example of a document formed with the security element;

FIG. 53 a twentieth embodiment example of a document formed with the security element;

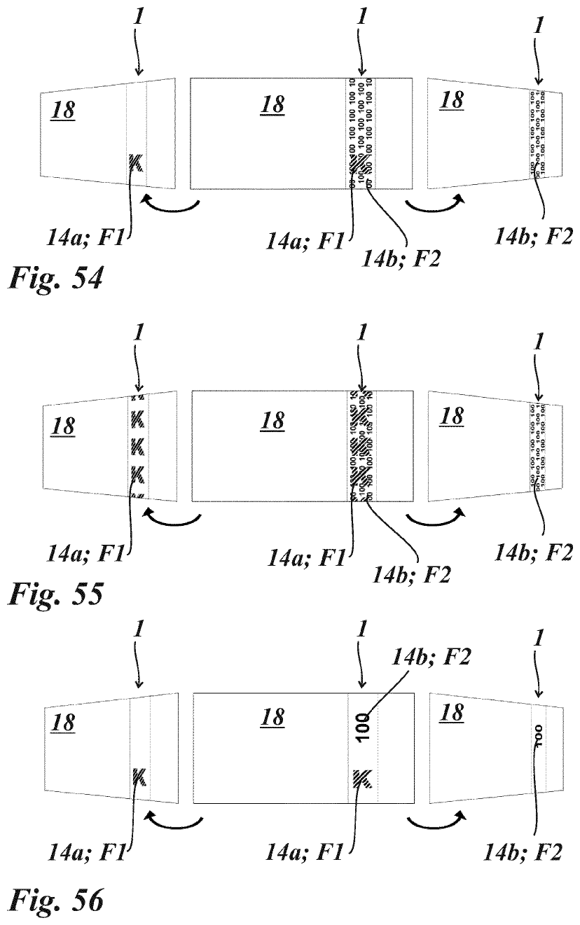

FIG. 54 a twenty-first embodiment example of a document formed with the security element;

FIG. 55 a twenty-second embodiment example of a document formed with the security element;

FIG. 56 a twenty-third embodiment example of a document formed with the security element;

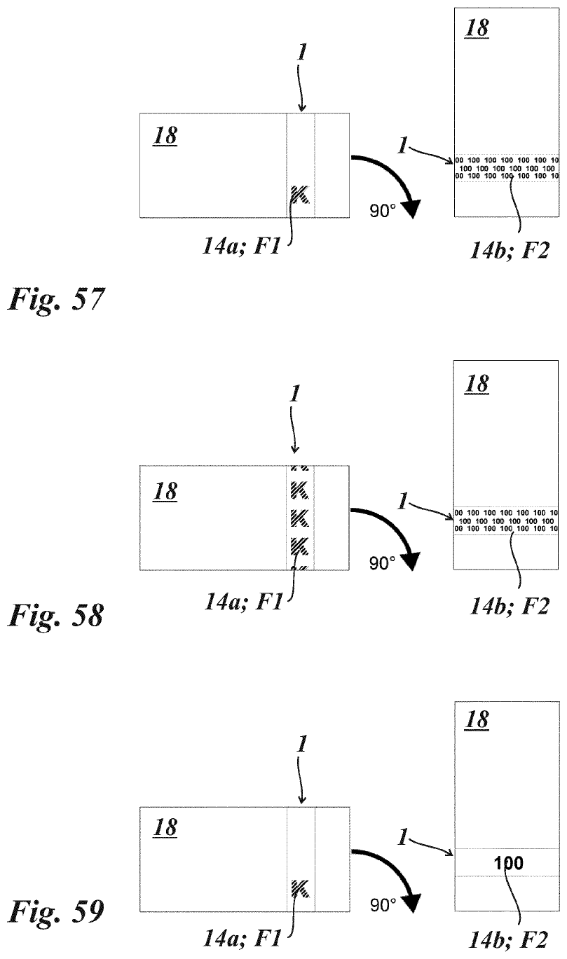

FIG. 57 a twenty-fourth embodiment example of a document formed with the security element;

FIG. 58 a twenty-fifth embodiment example of a document formed with the security element;

FIG. 59 a twenty-sixth embodiment example of a document formed with the security element;

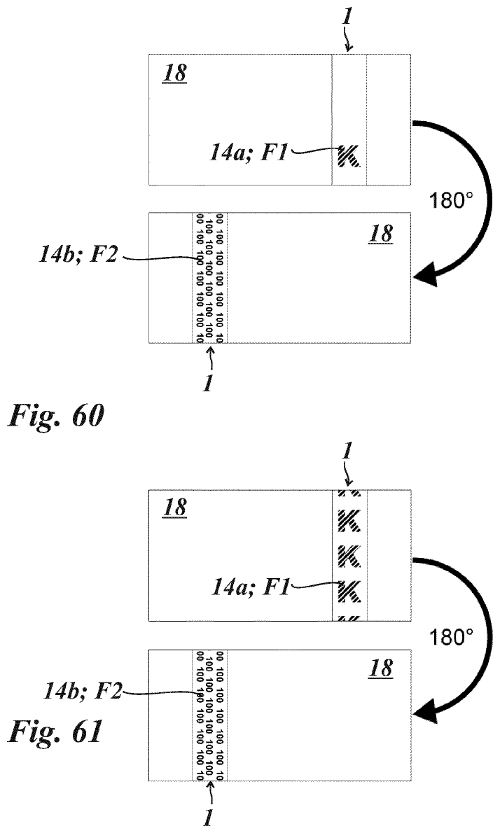

FIG. 60 a twenty-seventh embodiment example of a document formed with the security element;

FIG. 61 a twenty-eighth embodiment example of a document formed with the security element;

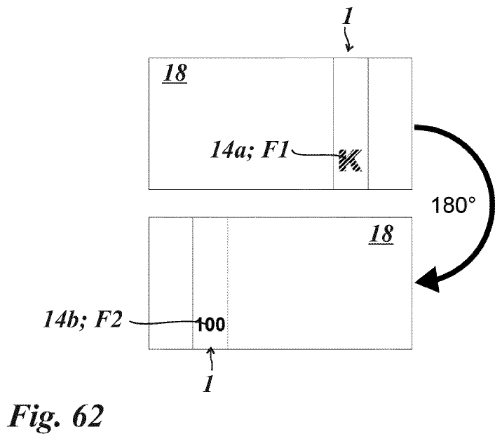

FIG. 62 a twenty-ninth embodiment example of a document formed with the security element.

FIGS. 1.1 to 1.11 show an embodiment example of the method according to the invention for producing a volume hologram film 1f, on which security elements 1 are successively arranged, in successive method steps. In FIGS. 1.1 to 1.11 in each case the security element 1 or an intermediate step of the security element which forms a section of the volume hologram film 1f is represented.

FIGS. 2, 3a and 3b show a device 2 provided for carrying out the method described in FIGS. 1.1 to 1.11.

In the embodiment example represented in FIG. 2 the device 2 comprises a supply roll 31, a first manufacturing station 3a, a second manufacturing station 3b, a third manufacturing station 4a, a fourth manufacturing station 4b, a fifth manufacturing station 5, a sixth manufacturing station 6 and a take-up roll 32.

In the first manufacturing station 3a, as described further below, a detachment layer is applied to the carrier film 11. In the second manufacturing station 3b a protective layer is applied to the detachment layer. It can also be provided to omit the detachment layer.

In the first embodiment example represented in FIG. 3a the third manufacturing station 4a and the fourth manufacturing station 4b have in each case a coating device 41, an exposure device 42 and a curing device 43.

The coating device 41 has a supply roll 41v for receiving a photopolymer film 12f and pressure rollers 41w. The photopolymer film 12f can be formed as a self-supporting film made of photopolymer material 12, but also as a carrier film with a non-self-supporting photopolymer layer 12 applied thereto. The photopolymer film 12f is pressed onto the coated carrier film 11 between the pressure rollers 41w.

The exposure device 42 comprises a first laser 42la preferably with downstream first optics and/or a first modulator 42ma, an optional second laser 42lb with preferably downstream second optics and/or a second modulator 42mb, a volume hologram master 9 and a UV light source 42u. The coated carrier film 11 is exposed with coherent light of the first laser 42la and the optional second laser 42lb in the exposure device 42 to record a volume hologram into the photopolymer layer 12. The photopolymer layer 12 is in direct or indirect contact with the volume hologram master 9, which is formed as a surface relief and/or as a volume hologram and in the embodiment example represented in FIG. 3a is arranged on the surface of a plate-shaped underlayer.

The UV light source 42u is arranged downstream behind the second laser 42lb, wherein the photopolymer layer 12 guided under the UV light source 42u is developed to form a volume hologram layer 13.

The volume hologram layer 13 is guided under a further UV light source 42u in the curing device 43 arranged downstream behind the exposure device 42 and completely hardened.

FIG. 3b shows a second embodiment example of the third and fourth manufacturing stations. The manufacturing stations 4a and 4b in each case have a first coating device 41a, an exposure device 42, a first curing device 43a, a second coating device 41b and a second curing device 43b.

A carrier film 11 formed as a multi-layer body with a detachment layer 17t and a protective layer 17s is fed to the first coating device 41a and coated with a photopolymer layer 12. The detachment layer 17t is optionally provided. For the formation of the photopolymer layer 12 a photopolymer material is deposited on the protective layer 17s of the carrier film 11 over the whole surface or partially by printing, spraying or casting.

The exposure device 42 is arranged downstream behind the first coating device 41a. The exposure device 42 comprises a first laser 42la with downstream first optics and a first modulator 42ma, a UV light source 42u as well as an exposure roller 42w, on which the coated carrier film 11 is guided. Optionally, a second laser 42lb with downstream second optics and a second modulator 42mb can be arranged downstream behind the first laser 42la, as represented in FIG. 3b. The coated carrier film 11 is exposed with coherent light of the first laser 42la and the second laser 42lb in the exposure device 42 to record a volume hologram into the photopolymer layer 12. The photopolymer layer 12 is in direct or indirect contact with a volume hologram master 9, not represented in FIG. 3b, which is formed as a surface relief and/or as a volume hologram and is arranged in or on the surface of the exposure roller 42w.

The UV light source 42u is arranged downstream behind the optional second laser 42lb, wherein the photopolymer layer 12 guided under the UV light source 42u is developed to form a volume hologram layer 13.

The volume hologram layer 13 is guided under a UV light source 42u in the first curing device 43a arranged downstream behind the exposure device 42 and completely hardened.

The second coating station 41b is arranged downstream behind the curing device 43a. In the second coating station an intermediate layer is applied to the carrier film 11 formed as a multi-layer body. The intermediate layer is then irradiated using a UV light source 42u, in order to achieve a complete hardening of the intermediate layer. Alternatively it can also be provided to provide a dryer instead of the UV light source 42u, if a thermally drying varnish is used for the intermediate layer.

FIG. 1.1 shows a first method step, in which a carrier film 11 arranged on the supply roll 31 (FIG. 2) is provided. The carrier film 11 can be a polyester film with a thickness in the range from 5 μm to 200 μm, preferably in the range from 10 μm to 30 μm.

FIG. 1.2 shows a second method step, in which a detachment layer 17t is applied to the carrier film 11 in the first manufacturing station 3a arranged downstream behind the supply roll 31. For this, the material which forms the detachment layer 17t is first applied to the carrier film 11 as a rule over the whole surface by printing, spraying or casting in a coating device. The applied layer is dried and/or cured in a drying and/or curing device arranged downstream behind the coating device. The detachment layer 17t is an optional layer.

FIG. 1.3 shows a third method step, in which a protective layer 17s is applied to the detachment layer 17t in the second manufacturing station 3b arranged downstream behind the first manufacturing station 3a. For this, the material which forms the protective layer 17s is first applied in a coating device as a rule over the whole surface by printing, spraying or casting. The applied layer is dried and/or cured in a drying and/or curing device arranged downstream behind the coating device.

FIG. 1.4 shows a fourth method step, in which a photopolymer layer 12 is applied to the coated carrier film 11 in the third manufacturing station 4a arranged downstream (FIG. 2). For the formation of the photopolymer layer 12 a photopolymer film 12f is unwound from the supply roll 41v, guided through between the pressure rollers 41w together with the carrier film 11 and pressed onto the upper side of the coated carrier film 11 (FIG. 3a). The photopolymer film 12f is formed from a photopolymer which can be crosslinked under the action in particular of laser radiation and/or UV light and in the process can in particular change its optical refractive index. For example, volume holograms can be formed by crosslinking in areas, as described further below. The photopolymer film 12f has a thickness in the range from 3 μm to 100 μm. The photopolymer film can be designed as a self-supporting film made of photopolymer material, but also as a carrier film with a photopolymer layer that is not self-supporting applied thereto. It can also be provided, for the formation of the photopolymer layer 12, to apply photopolymer material to the coated carrier film 11 over the whole surface or partially by printing, spraying or casting (FIG. 3b).

FIGS. 1.5 and 1.6 show a fifth method step, in which the coated carrier film 11 is fed to the exposure device 42 arranged downstream behind the coating device 41 (FIG. 2). The exposure device 42 has a first exposure station 42a, having a first laser 42la, preferably first optics and a first modulator 42ma, an optional second exposure station 42b, having a second laser 42lb, preferably second optics and a second modulator 42mb, as well as optional further exposure stations with further lasers, optics and modulators, a volume hologram master 9 as well as a UV light source 42u (FIG. 3a).

For the recording of a volume hologram the photopolymer layer 12 is exposed with coherent light of the first laser 42la and optionally of the second laser 42lb and optional further lasers and then irradiated using the UV light source 42u. During the recording, the coated carrier film 11 is preferably in direct or indirect contact with the volume hologram master 9 arranged under the carrier film 11. It can be provided to design the volume hologram master 9 as a flat volume hologram master 9, in particular arranged on a plate, as shown in FIG. 3a, or as a curved volume hologram master, in particular arranged in or on a lateral surface of a roller, as shown in FIG. 3b. The lasers 42la and 42lb, as well as the modulators 42ma and 42mb arranged in the beam path between the respective laser and the photopolymer layer 12 and/or a deflection element determining the angle of incidence of the exposure beams (not represented in FIG. 3a) are correspondingly actuated, with the result that the respective image area having a predetermined color value is exposed with a light with an exposure wavelength and/or with light striking at an angle which brings about a recording of a volume hologram image area with the predetermined color value and a predetermined range of angles of visibility. The incident exposure beams are superimposed here with the exposure beams reflected by the volume hologram master 9. Through this interference of the exposure beams, so-called Bragg planes are formed in the image area within the photopolymer layer. These Bragg planes are local changes in the refractive index within the photopolymer layer 12 which are optically active and thereby form the volume hologram.

Further, it is also possible to arrange exposure masks in the beam path between the lasers 42la, 42lb and the photopolymer layer 12, which determine the position and shaping of the image areas recorded by the respective laser 42la, 42lb. Then the exposed photopolymer layer 12 is guided under the UV light source 42u. In this way the photopolymer layer 12 is converted into a first volume hologram layer 13a.

The carrier film 11 coated with the optional detachment layer 17t and/or the optional protective layer 17s and the first volume hologram layer 13a is fed to the curing device 43 arranged downstream behind the exposure device 42, in order to achieve a complete hardening of the volume hologram layer 13a (FIG. 2). The curing device 43 has a UV lamp 42u (FIG. 3a).

FIG. 1.7 shows a sixth method step, which is formed like the fourth method step described further above in FIG. 1.4 with the difference that a further photopolymer layer 12 is applied to the first volume hologram layer 13a in the fourth manufacturing station 4b arranged downstream behind the third manufacturing station 4a (FIG. 2).

FIGS. 1.8 and 1.9 show a seventh method step, in which, analogously to the fifth method step described further above in FIGS. 1.5 and 1.6, a second volume hologram layer 13b is formed, which is arranged on the first volume hologram layer 13a.

For the formation of a further n volume hologram layers the sixth and seventh method steps can be repeated n times.

FIG. 1.10 shows an eighth method step, in which a background layer 15 is applied to the second volume hologram layer 13b in the fifth manufacturing station 5 arranged downstream behind the fourth manufacturing station 4b (FIG. 2). The background layer 15 can be formed as a color layer which is applied over the whole surface or partially in the decorative printing using the usual printing methods, for example gravure printing, screen printing, flexographic printing, inkjet printing or using other coating methods.

FIG. 1.11 shows a ninth method step, in which an adhesive layer 16 is applied to the background layer 15 in the sixth manufacturing station 6 arranged downstream behind the fifth manufacturing station 5 (FIG. 2).

The production process for a volume hologram film with a first embodiment example of the security element 1 is completed therewith. The volume hologram film 1f is fed to the take-up roll 32 arranged downstream behind the sixth manufacturing station 6 after the ninth method step (FIG. 2). During the application of the security element 1 to a substrate the adhesive layer 16 forms the undermost layer of the security element 1 formed as a multi-layer body.

It is particularly advantageous that, through the successive production of the multi-layered volume hologram film 1f from which the security elements 1 can be applied to the security document by transferring a transfer ply from a carrier film or by laminating, different exposure directions and/or different exposure wavelengths can be used and that different spatial directions in which a volume hologram can be observed and/or different colors of the volume holograms can thereby be achieved. For example, it is thereby possible that the volume hologram of the first volume hologram layer 13a is visible in red in the direction of travel of the volume hologram film 1f, while the volume hologram of the second volume hologram layer 13b is visible in green transverse to the direction of travel of the volume hologram film 1f.

Furthermore, it thereby also becomes possible to generate further volume holograms and optionally further layers with register accuracy or registration accuracy relative to preceding volume holograms and to match them with each other and arrange them one on another. In particular, the inline production described here without interposed winding up of the volume hologram film 1f makes a particularly precise relative alignment (register accuracy, registration accuracy) of the individual layers relative to each other possible.

Alternatively, it is also possible to apply the different volume hologram layers “offline” by successive steps in one and the same device and thereby to generate the multi-layered volume hologram film 1f. This means that after one pass the volume hologram film 1f is wound up and correspondingly unwound again for a further pass in the same device. A registration of the layers relative to each other is also possible here, but the precision is lower than in the above-described advantageous inline production.

FIG. 4 shows a second embodiment example of the security element 1, which is formed like the first embodiment example of the security element represented in FIG. 1.11 with the difference that the security element 1 additionally has intermediate layers:
a first intermediate layer 17a is arranged on the protective layer 17s;
a second intermediate layer 17b is arranged on the first volume hologram layer 13a;
a third intermediate layer 17c is arranged on the second volume hologram layer 13b.

It can be provided to form the security element 1 with the first intermediate layer 17a and/or with the second intermediate layer 17b and/or with the third intermediate layer 17c.

The intermediate layers 17a, 17b, 17c can be formed, for example, as functional layers, such as barrier layers and/or adhesion-promoter layers and/or as decorative layers, such as e.g. color layers and/or as whole-surface or partial reflective layers.

The above-named color layers can be formed, for example, from color-constant pigments and/or colorants and/or from optically variable inks (OVIs) and/or as a luminescent and/or phosphorescent color layer.

The reflective layer can be formed over the whole surface or partially as a metal layer and/or HRI layer.

The intermediate layers 17a, 17b, 17c can be formed as an endless motif and/or as individual images. Complementary motifs, interlacing, overlaps, multiple patches can thus further be formed.

When the applied security element 1 is observed, different optical effects can occur. While the background layer 15 is perceived in the same color at all observation angles, the optically variable volume holograms formed in the volume hologram layers 13a and 13b are visible only in certain angle ranges. If the color of the background layer 15 differs from the colors of the volume holograms, then the color impression of the respective volume hologram can be altered by the superimposition with the color of the background layer.

Table 1 shows some possibilities. For example, a green volume hologram which is formed in the volume hologram layer 13a or 13b appears in a blue-green to turquoise color on a purple background layer 15. On a pink-colored background layer 15, in contrast, it appears ocher.

TABLE 1

| | Color of the | Color of the | Resulting color |
|---|---|---|---|
| No. | volume hologram | background layer | impression |
| 1 | Green | Purple | Blue-green- |
| | | | turquoise |
| 2 | Green | Light yellow | Lemon yellow |
| 3 | Green | Pink | Ocher |
| 4 | Green | Red | Orange |
| 5 | Red | Purple | Pink |
| 6 | Red | Green | Orange |
| 7 | Red | Yellow | Light orange |
| 8 | Red | Pink | Dark pink |

FIG. 5 shows the principle of the additive color mixing, which is applicable to differently colored volume hologram layers which are arranged one over another and/or to the superimposition of differently colored, gridded or pixelated volume hologram areas arranged next to one another.

In the case of the RGB color model (RGB=red, green, blue), all colors of the RGB color space are additively composed of the three primary colors red, green and blue. Thus only three primary colors are used in order to generate all further colors by mixing them. If red and green are mixed in an equal ratio, then yellow is obtained; red and blue yield magenta; blue and green yield cyan. If all three primary colors are mixed, then white is obtained. The three primary colors red, green and blue are also called base colors. The colors which form by mixing the base colors are also called mixed colors.

As the mixed colors always result from additive superimposition of several base colors, the mixed colors are always lighter than the primary colors. Example: yellow forms due to the superimposition of red and green. Because yellow is lighter than red or green, it ultimately forms due to the intensity of two areas of surface or layers reflecting light simultaneously.

Whenever the three base colors are superimposed with almost equal intensity, thus e.g. 30% red, 30% green and 30% blue, an almost gray color shade forms. On a grayscale from 0% to 100%, 0% corresponds to a pure black, i.e. the RGB values are zero in each case, 100% corresponds to bright white, i.e. the RGB values are maximal in each case. In between there are gray values, which are also called achromatic colors. The more precisely the intensities of the three base colors coincide, the more achromatic the mixed color achieved is, because none of the three base colors stands out particularly in this mixed color.

The described color mixing also functions satisfactorily for many cases when only two primary colors are used, for example only red and blue or only red and green. Although no achromatic mixed colors are generated here, the resulting optical effect can make an almost achromatic impression on the human eye.

For the definition of the wavelength ranges of the three primary colors red, green and blue, there are various approaches in the literature. Typical values for this are, for example:

Red: in the range from 630 nm to 700 nm
Green: in the range from 490 nm to 560 nm
Blue: in the range from 450 nm to 490 nm

An established international definition is e.g. a wavelength of 700 nm for red, 546 nm for green and 436 nm for blue.

FIG. 6 shows the principle of the additive color mixing in the case of two differently colored volume hologram layers lying one over the other. In the diagram represented in FIG. 6 the x-axis denotes angle γ, at which a volume hologram is visible, the y-axis denotes the intensity of a color of the volume hologram. If the volume holograms are formed such that the first volume hologram in a first volume hologram layer becomes visible with a color F1 at an angle γ₁ and at the same time the second volume hologram in a second volume hologram layer lying over or underneath that becomes visible with a color F2 at the same or a very similar angle, then the colors F1 and F2 of the volume holograms are superimposed in such a way that a volume hologram becomes visible with the mixed color of colors F1 and F2 at the angle γ₁.

FIG. 7 shows a schematic representation of the geometric conditions during observation of a volume hologram. A security element 1 arranged on a document 18 has a second volume hologram layer 13b with a second volume hologram and a color F2, a second intermediate layer 17b, a first volume hologram layer 13a with a first volume hologram and a color F1, a first intermediate layer 17a and a protective layer 17s. The security element 1 is applied with the adhesive layer 16 to the document 18 and is covered by the protective layer 17s. The security element 1 is illuminated by a light source 7, which ideally emits white light. The colors F1 and F2 are superimposed in the eye of an observer 8 to form a mixed color. For example, a yellow color impression can be generated by superimposition of a red and a green volume hologram. However, it is also possible to generate an achromatic white or a gray volume hologram for example by superimposition of a blue and a yellow volume hologram. Table 2 shows some possibilities which result in the case of the superimposition of two volume hologram layers.

TABLE 2

| | Color of the first | Color of the second | Resulting color |
|---|---|---|---|
| No. | volume hologram | volume hologram | impression |
| 1 | Red | Green | Yellow |
| 2 | Green | Red | Yellow |
| 3 | Red | Blue | Magenta |
| 4 | Blue | Red | Magenta |
| 5 | Green | Blue | Cyan |
| 6 | Blue | Green | Cyan |
| 7 | Blue | Yellow | White or gray |
| 8 | Yellow | Blue | White or gray |

The same applies to the superimposition of differently colored, gridded or pixelated volume hologram areas arranged next to one another. If, for example, green and red volume hologram areas are arranged gridded in each other and next to one another, then a yellow color impression forms.

FIG. 8 shows the principle of color mixing in the case of three differently colored volume hologram layers lying one over another. If the volume holograms are formed such that the first volume hologram in a first volume hologram layer becomes visible with a color F1 at an angle γ₁, that at the same time the second volume hologram in a second volume hologram layer becomes visible with a color F2 at the same or a very similar angle, and that at the same time the third volume hologram in a third volume hologram layer becomes visible with a color F3 at the same or a very similar angle, then the colors F1 to F3 are superimposed in such a way that a volume hologram becomes visible with a mixed color at the angle γ₁.

FIG. 9 shows a schematic representation of the geometric conditions during observation of a security element which is formed as described in FIG. 8. A security element 1 is formed like the security element described in FIG. 7 with the difference that the security element 1 has a third volume hologram layer 13c with a third volume hologram and a color F3 as well as a third intermediate layer 17c, which is arranged between the third volume hologram layer 13c arranged on the document 18 and the second volume hologram layer 13b. The colors F1 to F3 are superimposed in the eye of the observer 8 to form a mixed color, as represented in FIG. 8. For example, a gray or a white color impression can be generated by superimposition of a red, a green and a blue volume hologram in the various volume hologram layers. The same applies to the superimposition of differently colored, gridded or pixelated volume hologram areas arranged next to one another. If, for example, red, green and blue volume hologram areas are arranged gridded next to one another, then an achromatic, in particular gray or a white color impression forms.

Through the gridded design of the volume hologram layers 13a to 13c, it is possible in principle to generate a gridded true-color image, for example a true-color motif, such as a portrait.

The following FIGS. 10 to 12 show embodiment examples of a document 18 formed with the security element 1. The document 18 has a longitudinal axis aₗ which is aligned with the longitudinal extent of the document 18 and a transverse axis a_{q} which is aligned with the transverse extent of the document 18. The document 18 can be, for example, a bank card, a credit card, an identity card or a banknote.

The strip-shaped security element 1 is arranged on the upper side of the document 18. The background layer 15 of the security element 1 is formed with a color F1, which is indicated by hatching. In the lower section of the figures the document 18 is represented as it appears when observed perpendicularly in the transverse position. In the upper section of the figures the document 18 is represented in perspective in a tilted position, which it adopts after a tilting about the longitudinal axis aₗ. The tilting is illustrated by a directional arrow.

FIG. 10 shows a first embodiment example of the document 18, which is formed with a security element 1, as described in FIG. 1.9 and FIG. 4.

In the case of perpendicular observation of the document 18 a first volume hologram with a first motif 14a (for example the letter “A”) and a color F2, which is formed in the first volume hologram layer 13a, is visible in a first position. If the document 18 is tilted about the longitudinal axis aₗ, then a second volume hologram with a second motif 14b (for example the letter “B”) and a color F3 becomes visible in a second position at a particular tilt angle. The second volume hologram can be formed in the first volume hologram layer 13a or in the second volume hologram layer 13b. If the color F1 of the background layer 15 is, for example, a light yellow, then a green first volume hologram appears lemon yellow in front of this background color, while a red second volume hologram appears in a light orange. The color F2 and the color F3 can also be the same.

FIG. 11 shows a second embodiment example of the document 18. The document 18 is formed like the document described in FIG. 10 with the difference that when the document 18 is tilted the first volume hologram changes its color, but the motif is retained.

The first volume hologram, which can be formed in the first volume hologram layer 13a or in the second volume hologram layer 13b, is visible in a color F2, for example in red, in the case of perpendicular observation. If the document 18 is tilted, then the first volume hologram is visible in a color F3, for example in green, at a particular tilt angle. This color impression is altered by the color F1 of the background layer 15. A mixed color is formed, as explained in more detail further above in FIG. 5. If the color F1 of the background layer 15 is, for example, a light yellow, then the first volume hologram appears in a light orange in front of this background color. If the document 18 is tilted, then the first volume hologram appears in lemon yellow.

FIG. 12 shows a third embodiment example of the document 18. The document 18 is formed like the document described in FIG. 10 with the difference that it shows a different optical effect at three different tilt angles.

A first volume hologram formed in the first volume hologram layer 13a with a first motif 14a and a color F2 is visible in a first position when the document 18 is observed perpendicularly. If the document 18 is tilted by a first tilt angle, then a second volume hologram with a second motif 14b and a color F3 is visible in a second position. The second volume hologram can be formed in the first volume hologram layer 13a or in the second volume hologram layer 14b. If the document 18 is tilted by a second tilt angle which is greater than the first tilt angle, then a third volume hologram with a third motif 14c and a color F4 is visible in a third position. The third volume hologram can be formed in the first volume hologram layer 13a, in the second volume hologram layer 13b or in a third volume hologram layer 13c. If the color F1 of the background layer 15 is, for example, a light yellow, then a green first volume hologram appears in lemon yellow in front of this background color F1, while a red second volume hologram appears in a light orange and a blue third volume hologram appears in green. The colors F1 to F3 of the three volume holograms can also be the same, as in the embodiment example represented in FIG. 12.

FIG. 13 shows a third embodiment example of the security element 1. The security element 1 is formed like the security element described further above in FIG. 4 with the difference that the background layer is formed as an optically variable color layer 15o and that a fourth intermediate layer 17d is arranged between the optically variable color layer 15o and the adhesive layer 16. An optically variable color layer is a special printed color layer which changes color depending on the observation angle. It contains, for example, optically variable pigments which generate a color shift in the case of a variation of the observation angle. The optically variable color layer 15o appears, for example, in a color F1, e.g. crimson, in the case of perpendicular observation, and appears in a color F2, e.g. olive green or brown, in the case of inclined observation.

The intermediate layer 17d can be formed, like the intermediate layers 17a, 17b, 17c, for example as a functional layer, such as a barrier layer and/or an adhesion-promoter layer and/or as a decorative layer, such as e.g. a color layer and/or as a whole-surface or partial reflective layer.

While the optically variable color layer 15o is perceived at all observation angles, wherein the color varies depending on the observation angle, the volume holograms formed in the volume hologram layers 13a and 13b are visible only in certain angle ranges. If the color of the optically variable color layer 15o differs, at a certain observation angle, from the color of the respective volume hologram at this observation angle, then the color impression of the respective volume hologram is altered by the superimposition with the color of the optically variable color layer 15o lying in the background. Because the color of the optically variable color layer 15o varies depending on the observation angle, it becomes possible to alter the color impressions of the different volume hologram layers differently.

FIGS. 14 to 16 show embodiment examples of a document 18, which is formed with the security element described in FIG. 13.

FIG. 14 shows a fourth embodiment example of the document 18.

A first volume hologram formed in the first volume hologram layer 13a with a first motif 14a and a color F1 is visible in a first position in the case of perpendicular observation. If the document 18 is tilted about its longitudinal axis, then a second volume hologram with a second motif 14b and a color F2 is visible in a second position at a particular tilt angle. The second volume hologram can be formed in the first volume hologram layer 13a or in the second volume hologram layer 13b. The color of the optically variable color layer 15o changes from a color F3 to a color F4 when the document 18 is tilted. If the color F3, perceptible when the document 18 is observed perpendicularly, of the optically variable color layer 15o is, for example, lilac, then a green first volume hologram appears in turquoise. If the color F4, perceptible when the document 18 is tilted, of the optically variable color layer 15o is, for example, green or olive green, then a red second volume hologram appears in orange. Both volume holograms can also have the same color F1, F2.

FIG. 15 shows a fifth embodiment example of the document 18. The document 18 is formed like the document described in FIG. 14 with the difference that the first volume hologram changes its color when the document 18 is tilted.

A first volume hologram formed in the first volume hologram layer 13 or in the second volume hologram layer 14 appears in a color F1, for example green, in the case of perpendicular observation. If the document 18 is tilted, then the first volume hologram is visible in a color F2, for example red, at a particular tilt angle. If the color F3 of the optically variable color layer 15o in the case of perpendicular observation is, for example, lilac, then the first volume hologram, green in the case of perpendicular observation, appears in turquoise. If the color F4 of the optically variable color layer 15o in the tilted state is green or olive green, then the first volume hologram, red in the tilted state, appears in orange.

FIG. 16 shows a sixth embodiment example of the document 18. The document 18 is formed like the document described in FIG. 14 with the difference that it shows a different optical effect at three different tilt angles.

A first volume hologram formed in the first volume hologram layer 13a with a first motif 14a and a color F1 is visible in a first position in the case of perpendicular observation. If the document 18 is tilted about its longitudinal axis, then a second volume hologram with a second motif 14b and a color F2 becomes visible in a second position at a particular tilt angle. The second volume hologram can be formed in the first volume hologram layer 13a or in the second volume hologram layer 13b. If the document 18 is tilted further, then a third volume hologram with a third motif 14c and a color F3 is visible in a third position at a greater tilt angle. The third volume hologram can be formed in the first volume hologram layer 13a, in the second volume hologram layer 13b or in a third volume hologram layer. The volume holograms can have the same color, as represented in FIG. 16, but they can also have different colors. If a color F4 of the optically variable color layer 15o in the case of perpendicular observation is, for example, lilac, then a green first volume hologram appears in turquoise. In the case of a tilting by a particular angle the optically variable color layer 15o appears in a color F5, for example brown. For example a green second volume hologram thereby appears in ocher. If on the other hand a color F6 of the optically variable color layer 15o in the greatly tilted state is green or olive green, then a red third volume hologram appears in orange.

FIG. 17 shows a fourth embodiment example of the security element. A security element 1 is formed like the security element described further above in FIG. 13 with the difference that the background layer is formed not as an optically variable color layer, but as a thin-film element 15d. The thin-film element 15d has a semi-transparent first reflective layer 19ra, a highly reflective second reflective layer 19rb and a transparent spacer layer 19a arranged between the first reflective layer 19ra and the second reflective layer 19rb. The thickness of the spacer layer 19a lies in the range of half the wavelength of visible light, thus in the range from 200 to 500 nm. Such a thin-film element 15d has a color-change effect that is dependent on the observation and/or illumination angle.

While the optically variable thin-film element 15d is perceived colored at most observation angles and/or illumination angles, wherein the color varies depending on the observation angle and/or illumination angle, the optically variable volume holograms of the volume hologram layers 13a and 13b are visible only in certain angle ranges. If the color of the thin-film element 15d differs, at a certain observation angle, from the color of the respective volume hologram at this observation angle, then the color impression of the respective volume hologram is altered by the superimposition with the color of the thin-film element 15d lying in the background. Because the color of the thin-film element 15d varies depending on the observation angle, it becomes possible to obtain different color impressions of the volume hologram layers 13a, 13b depending on the observation angle and/or illumination angle.

FIGS. 18 to 20 show documents which are formed with the security element described above.

FIG. 18 shows a seventh embodiment example of a document 18 formed with the security element 1.

A first volume hologram formed in a first volume hologram layer 13a with a first motif 14a and a color F1 is visible in a first position when the document 18 is observed perpendicularly. If the document 18 is tilted about its longitudinal axis, a second volume hologram with a second motif 14b and a color F2 is visible in a second position at a particular tilt angle. The second volume hologram can be arranged in the first volume hologram layer 13a or in the second volume hologram layer 13b.

If the thin-film element 15d appears in a color F3, for example lilac, in the case of perpendicular observation, then a green first volume hologram appears in turquoise. If on the other hand the thin-film element 15d appears in a color F4, for example in green or in olive green, in the tilted state, then a red second volume hologram appears in orange. The two volume holograms can also have the same color.

FIG. 19 shows an eighth embodiment example of a document 18 formed with the security element 1. The document 18 is formed like the document described in FIG. 18 with the difference that the first volume hologram changes its color when the document 18 is tilted.

The first volume hologram, which is formed in the first volume hologram layer 13a or in the second volume hologram layer 13b, is visible in a color F1, for example in green, in the case of perpendicular observation of the document 18. If the document 18 is tilted about its longitudinal axis, then the first volume hologram is visible in a color F2, for example in red, at a particular tilt angle. If the color F3 of the thin-film element 15d is, for example, lilac in the case of perpendicular observation, then the first volume hologram, green in the case of perpendicular observation, appears in turquoise. If on the other hand the color F4 of the thin-film element 15d is green or olive green in the tilted state, then the first volume hologram, red in the tilted state, appears in orange.

FIG. 20 shows a ninth embodiment example of a document 18 formed with the security element 1. The document 18 is formed like the document described in FIG. 18 with the difference that it shows different optical effects at three different tilt angles.

A first volume hologram with a first motif 14a and a color F1, which is formed in the first volume hologram layer 13a, is visible in a first position when the document 18 is observed perpendicularly. If the document 18 is tilted, then a second volume hologram with a second motif 14b and a color F2 is visible in a second position at a particular tilt angle. The second volume hologram can be formed in the first volume hologram layer 13a or in the second volume hologram layer 13b. If the document 18 is tilted further, then a third volume hologram with a third motif 14c and a color F3 is visible in a third position at a greater tilt angle. The third volume hologram can be formed in the first volume hologram layer 13a, in the second volume hologram layer 13b or in a third volume hologram layer 13c. The three volume holograms can have the same color, as represented in FIG. 20, but they can also have different colors. If the color F4 of the thin-film element 15d is, for example, lilac in the case of perpendicular observation, then a green first volume hologram appears in turquoise. In the case of a tilting by a particular angle the thin-film element 15d appears in a color F5, for example in brown. For example a green second volume hologram thereby appears in ocher. If on the other hand the color F6 of the thin-film element 15d is green or olive green in the greatly tilted state, then a red third volume hologram appears in orange.

FIG. 21 shows a fifth embodiment example of the security element. A security element 1 is formed like the security element described further above in FIG. 17 with the difference that the background layer has a mask layer 15m, which has a metallic layer 20 with a fourth intermediate layer 17d laid behind it.

The metallic layer 20 can be formed over the whole surface or, as represented in FIG. 21, be formed only in partial areas. The metallic layer 20 preferably consists of aluminum, copper, gold, silver, chromium, tin or an alloy of these materials and has a thickness of from 0.1 nm to 1000 nm, preferably from 5 nm to 100 nm.

For the production of a partial metallic layer 20 the optional third intermediate layer 17c or the second volume hologram layer 13b is preferably coated over the whole surface with a metal or a metal alloy and then the metal or the metal alloy is subsequently removed again in areas, for example by positive/negative etching or by means of ablation. Further, it is also possible that the metallic layer 20 is applied to the optional third intermediate layer 17c or the second volume hologram layer 13b, for example by means of vapor-deposition masks, only in areas and in some circumstances patterned.

After application of the security element 1 to a document the metallic layer 20 is arranged underneath the volume hologram layers 13a and 13b and can have the effect, firstly, that the surface of the document is covered and thereby the volume holograms lying on top are not superimposed by the color and shape of any printing on the document. Moreover, the visibility of the volume holograms can increase, as the metallic layer 20 becomes dark when the document 18 is tilted beyond the mirror reflex.

FIG. 22 shows a sixth embodiment example of the security element. A security element 1 is formed like the security element described in FIG. 17 with the difference that the background layer is formed as an absorption layer 15a. The absorption layer 15a is formed as a dielectric filter made of four layers in FIG. 22, having a first filter layer 21a, a second filter layer 21b, a third filter layer 21c and a fourth filter layer 21d. In the embodiment example represented in FIG. 22 a fourth intermediate layer 17d is arranged between the adhesive layer 16 and the absorption layer 15a.

The absorption layer 15a can be formed over the whole surface or also only in partial areas. In the conventional sense these are, firstly, non-tunable Fabry-Perot interferometers, which consist, for example, of a semi-transparent metallic mirror layer (e.g. made of aluminum or silver), followed by a thin dielectric and transparent layer and a second mirror layer (multiple interference filter). The layer thickness of the dielectric layer is used to set what wavelengths are absorbed. In addition, there are increasingly more elaborate interference filters which are constructed from dielectric (non-metallic) layers alone without reflective layers, so-called dielectric filters. As a rule layers of two different transparent materials with different refractive indices alternate, wherein a different thickness from layer to layer can be necessary. There are also cases in which more than two materials are used. The thicknesses of the individual layers lie between approximately 10 and 1000 nm. The number of layers can lie between a few hundred and several hundred depending on the requirements of the filter. For example SiO₂, ZnS or TiO₂, which have different refractive indices, are used as materials.

For the production of a partial absorption layer the absorption layer 15a is preferably applied to the optional third intermediate layer 17c or the second volume hologram layer 13b over the whole surface and then the absorption layer 15a is subsequently removed again in areas, for example by positive/negative etching or by means of ablation. Further it is also possible that the absorption layer 15a is applied to the optional third intermediate layer 17c or the second volume hologram layer 13b, for example by means of masks, only in areas and in some circumstances patterned.

After application of the security element 1 to a document the absorption layer 15a is arranged underneath the volume hologram layers 13a and 13b and can have the effect, firstly, that the surface of the document is covered and thereby, at least in areas, the volume holograms lying on top are not superimposed by the color and shape of any printing on the document. Moreover the visibility of the volume holograms can increase, as the absorption layer 21 absorbs the incident light at least in particular wavelength ranges.

FIG. 23 shows a seventh embodiment example of the security element. A security element 1 is formed like the security element described in FIG. 17 with the difference that the background layer is formed as a microstructure layer 15s, which has a third intermediate layer 17c formed as a replication layer and a metallic layer 20 applied to a surface microstructure of the intermediate layer 17c.

The third intermediate layer 17c formed as a replication layer can be formed from a thermoplastic, in the upper side of which areas with a surface microstructure are formed. The surface microstructure can be formed, for example, as a linear or crossed sinusoidal grating, an asymmetrical blazed grating, an isotropic or anisotropic matte structure, a lens structure or combinations of the above structures or as a surface hologram. The sinusoidal gratings have periods in a range from 0.2 μm to 10 μm, preferably in a range from 0.5 μm to 2.0 μm, and depths in a range from 30 nm to 5000 nm, preferably in a range from 80 nm to 300 nm.

The metallic layer 20 can be formed over the whole surface, as represented in FIG. 23, or be formed only in partial areas. The metallic layer 20 preferably consists of aluminum, copper, gold, silver, chromium, tin or an alloy of these materials and has a thickness of from 0.1 nm to 1000 nm, preferably from 5 nm to 100 nm. For the production of a partial metallic layer 20 the third intermediate layer 17c is preferably coated over the whole surface with a metal or a metal alloy and then the metal or the metal alloy is subsequently removed again in areas, for example by positive/negative etching or by means of ablation. Further, it is also possible that the metallic layer 20 is applied to the third intermediate layer 17c, for example by means of vapor-deposition masks, only in areas and in some circumstances patterned.

After application of the security element 1 to a document the microstructure layer 15s is arranged underneath the volume hologram layers 13a and 13b and has the effect, firstly, that the surface of the document is covered and thereby, at least in the metallized areas, the volume holograms lying on top are not superimposed by the color and shape of any printed image on the document. Moreover, the visibility of the volume holograms increases, as the metallic layer 20 becomes dark when the document is tilted beyond the mirror reflex.

Depending on the design of the holograms used, the volume holograms formed in the volume hologram layers 13a and 13b and a metallized surface hologram formed in the microstructure layer 15s become visible at the same observation angle or else at different observation angles. The combination of the volume holograms normally appearing monochrome with the metallized surface holograms appearing in several prismatic colors results in very interesting color effects which in addition can be forged only with great difficulty.

FIG. 24 shows an eighth embodiment example of the security element. A security element 1 is formed like the security element described in FIG. 23 with the difference that, instead of the metallic layer 20, an HRI layer 22 (HRI=High Refractive Index) with a high refractive index is provided. The HRI layer 22 can be formed, for example, of ZnS and cover the surface structure of the third intermediate layer 17c formed as a replication layer over the whole surface. The HRI layer 22 is almost transparent in the visible spectral range above 500 nm.

After application of the security element 1 to a document the microstructure layer 15s formed from the third intermediate layer 17c and the HRI layer 22 is arranged underneath the volume hologram layers 13a and 13b and has the effect, firstly, that a surface hologram formed in the third intermediate layer 17c is visible under the volume holograms and that any printed image on the document remains visible.

Depending on the design of the holograms used, the volume holograms formed in the volume hologram layers 13a and 13b and the surface hologram formed in the microstructure layer 15s are visible at the same observation angle or at different observation angles.

FIG. 25 shows a ninth embodiment example of the security element. A security element 1 is formed like the security element described further above in FIG. 21 with the difference that the mask layer 15m has a color layer 15f present in areas, a fourth intermediate layer 17d, a metallic layer 20 and an optional fifth intermediate layer 17e. The adhesive layer 16 is arranged on the fifth intermediate layer 17e.

The color layer 15f is applied to the optionally present third intermediate layer 17c or directly to the second volume hologram layer 13b using the usual printing or coating methods. Then the fourth intermediate layer 17d and the metallic layer 20 are applied over the whole surface, as represented in FIG. 25, or in areas.

After application of the security element 1 to a document the color layer 15f and the metallic layer 20 are arranged underneath the volume hologram layers 13a and 13b and can have the effect, firstly, that the surface of the document is covered and thereby the volume holograms lying on top are not superimposed by the color and shape of any printing on the document. Moreover the visibility of the volume holograms can increase, as the color layer 15f absorbs light in particular in the case of dark colors and the metallic layer 20 becomes dark when the document is tilted beyond the mirror reflex. However, the metallization, in particular when dark colors are used, is not visible over the whole surface due to the partial printing of the color layer 15f, which corresponds to a demetallization effect.

If the metallic layer 20 is applied not over the whole surface but only in areas, then any printed image on the document can remain visible in the areas which have neither a color layer 15f nor a metallization 20.

Conversely, the color layer 15f and the metallization 20 can be particularly visible in the observation or illumination situations in which the volume holograms lying on top are not or are barely visible.

FIG. 26 shows a tenth embodiment example of the security element. A security element 1 is formed like the security element described in FIG. 25 with the difference that the fourth intermediate layer 17d is formed as a replication layer, into which a surface relief is molded, as described further above in FIG. 23. The metallic layer 20 applied to the fourth intermediate layer 17d can be formed over the whole surface or, as represented in FIG. 26, in areas. The color layer 15f is applied to the optionally present third intermediate layer 17c or directly to the second volume hologram layer 13b using the usual printing or coating methods (e.g. gravure printing, screen printing, flexographic printing, inkjet printing).

After application of the security element 1 to a document the color layer 15f and the metallized fourth intermediate layer 17d are arranged underneath the volume hologram layers 13a and 13b and form three different undercoats underneath the volume hologram layers 13a and 13b.

In the areas in which the color layer 15f is present the surface of the document is covered, in particular when dark colors are used. The volume holograms lying on top are thereby not superimposed by the color and shape of any printing on the document, and the volume holograms are more visible.

In the areas in which a color layer 15f is not formed but a metallization 20 is formed on the fourth intermediate layer 17d, the surface of the document is covered and a metallized surface hologram or a metallized mirror surface appears under the volume holograms.

In the areas in which the color layer 15f is not formed and also the fourth intermediate layer 17d is not formed metallized, a printed image appears on the document or the document is visible under the volume holograms.

FIG. 27 shows an eleventh embodiment example of the security element. A security element 1 is formed like the security element described in FIG. 4 with the difference that the background layer is formed as a fluorescent layer 15f1. The fluorescent layer 15f1 can be formed over the whole surface or in areas.

The fluorescent layer 15f1 is formed of a varnish made of fluorescent organic and inorganic pigments dissolved in a thiophene-benzoaxol derivative. The fluorescent layer 15f1 is applied over the whole surface or partially in the decorative printing using the usual printing methods, for example gravure printing, screen printing, flexographic printing, inkjet printing or using other coating methods. The layer thickness is preferably between 0.1 μm and 6 μm after the drying.

After application of the security element 1 to a document the fluorescent layer 15fl is arranged underneath the volume hologram layers 13a and 13b. While the fluorescent layer 15f1 appears in shades of gray when irradiated with daylight, conditional on the intrinsic color of the fluorescent pigments, it lights up colored when irradiated with UV light (wavelengths of, for example, 365 nm or 254 nm). The volume holograms lying on top can thereby be more visible and/or the volume holograms can appear in another color shade through superimposition.

FIG. 28 shows a twelfth embodiment example of the security element. A security element 1 is formed like the security element described in FIG. 27 with the difference that, instead of the fluorescent layer, a phosphorescent layer 15p is provided. The phosphorescent layer 15p can be formed over the whole surface or in areas.

The phosphorescent layer 15p is applied over the whole surface or partially in the decorative printing using the usual printing methods, for example gravure printing, screen printing, flexographic printing, inkjet printing or using other coating methods.

After application of the security element 1 to a document the phosphorescent layer 15p is arranged underneath the volume hologram layers 13a and 13b. While the phosphorescent layer 15p appears in shades of gray when irradiated with daylight, conditional on the intrinsic color of the phosphorescent pigments, it lights up colored when irradiated with UV light. The volume holograms lying on top can thereby be more visible and/or the volume holograms can appear in another color shade through superimposition. This is of particular interest because the phosphorescent pigments, unlike fluorescent pigments, emit an afterglow for a particular time and thereby the better visibility of the volume holograms and/or the altered color shade of the volume holograms is preserved for a particular time after the illumination with UV light.

FIG. 29 shows a thirteenth embodiment example of the security element. A security element 1 has the following layer structure:

A first intermediate layer 17a and a second intermediate layer 17b are arranged on an in particular coated or also uncoated carrier film 11. The second intermediate layer 17b is formed as a replication layer, as described further above in FIGS. 23, 24 and 26. A metallic layer 20 is applied to the second intermediate layer 17b. The second intermediate layer 17b can be formed from a thermoplastic, in the upper side of which areas are formed into which relief structures preferably formed as blazed gratings are molded. The blazed gratings have periods in a range from 0.2 μm to 15 μm, preferably in a range from 0.5 μm to 7.0 μm, and depths in a range from 50 nm to 5000 nm, preferably in a range from 100 nm to 1500 nm. Alternatively, sinusoidal gratings, matte structures, lens structures etc. can also be used instead of the blazed gratings.

The metallic layer 20 is formed, as represented in FIG. 29, only in partial areas. The metallic layer 20 preferably consists of aluminum, copper, gold, silver, chromium, tin or an alloy of these materials and has a thickness of from 0.1 nm to 1000 nm, preferably from 5 nm to 100 nm. For the production of a partial metallic layer 20 the second intermediate layer 17b is preferably coated over the whole surface with a metal or a metal alloy and then the metal or the metal alloy is subsequently removed again in areas, for example by positive/negative etching or by means of ablation. Further, it is also possible that the metallic layer 20 is applied to the second intermediate layer 17b, for example by means of vapor-deposition masks, only in areas and in some circumstances patterned.

A third intermediate layer 17c is arranged on the second intermediate layer 17b and thus also on the metallic layer 20. The further layer structure provides a first volume hologram layer 13a, a fourth intermediate layer 17d, a second volume hologram layer 13b, a fifth intermediate layer 17e and finally an adhesive layer 16.

After application of the security element 1 to a document the volume hologram layers 13a and 13b are arranged underneath the second intermediate layer 17b metallized in areas and are visible in the areas in which there is no metallization. In the areas in which there is metallization, on the other hand, only a metallized surface hologram or a metallized mirror surface which is formed in the second intermediate layer 17b is visible, for example.

A particularly advantageous embodiment of the security element 1 is represented in FIG. 30. The security element 1 in FIG. 30 is formed like the security element described in FIG. 29 with the difference that the metallic layer 20 is formed grid-shaped, preferably is formed as a line grid. For example, a metallized surface hologram and the volume holograms lying underneath it can thereby, after application of the security element 1 to a document, be visible simultaneously in particular observation or illumination situations.

FIG. 31 shows a fifteenth embodiment example of the security element. A security element 1 is formed like the security element described further above in FIG. 29 with the difference that, instead of or in addition to the metallic layer 20, an HRI layer 22 is provided, which covers the surface structure of the second intermediate layer 17b over the whole surface, as portrayed in FIG. 31, or in areas.

The HRI layer 22 has a high refractive index and is formed, for example, from SiO₂, ZnS or TiO₂. The HRI layer is almost transparent in the spectral range above approximately 500 nm.

After application of the security element 1 to a document the volume hologram layers 13a and 13b are arranged underneath the second intermediate layer 17b with the transparent HRI layer 22 laid behind it. Thus, depending on the illumination and observation angle, for example, either the surface hologram which is formed in the second intermediate layer 17b or the volume holograms is/are visible, or else the surface hologram and the volume holograms are visible simultaneously.

FIG. 32 shows a tenth embodiment example of a document 18 formed with the security element 1. The document 18 is, for example, a banknote or an identity document. In the embodiment example represented in FIG. 32 a first strip-shaped security element 1 is arranged on the upper side of the document 18 and a second security element 1′ is arranged in a window 18f of the document 18. The first security element 1 can also be formed as a patch not in the shape of a strip or as an overlay covering the document 18 largely over the whole surface.

The first security element 1 is transferred from the volume hologram film 1f described further above to the document 18. If the volume hologram film 1f is formed as a transfer film, the carrier film 11 is detached from the transfer ply after application of the transfer ply to the document 18. If the volume hologram film 1f is formed, on the other hand, as a laminating film, then the carrier film 11 remains on the document 18 after application as the uppermost layer of the security element 1.

The window 18f is formed as a transparent area of the document 18 in the embodiment example represented in FIG. 32. The window 18 can be formed, for example, as a transparent area of a polymer banknote or as a punched hole in a paper banknote. Furthermore, it can also be, e.g., a transparent area in an ID card, e.g. made of polycarbonate or the like. Depending on the application case, the volume hologram film 1f can be formed for application to the window 18f as a transfer film or as a laminating film. Visual features in the transparent areas of the document 18 can be formed differently and are divisible into three groups:
features which are visible in reflection, visible when the front side of the document 18 is observed;
features which are visible in reflection, visible when the rear side of the document 18 is observed;
features which are visible in transmission, i.e. when the document 18 is held in front of a light source.

In particular the combination of a feature which is visible in reflection with a feature which is visible only in transmission yields a surprise effect for the observer, as the conditions for the transmission feature are only rarely met, e.g. when a banknote is held against the light. Thus, this transmission feature is almost always invisible; only in transmission, observed against a light source, does an item of information appear (e.g. the denomination of the banknote). A combined item of information is a visually interesting feature which is at the same time very secure against forgery.

FIG. 33 shows the general geometric conditions when a (reflection) volume hologram is observed. A security element 1, which is arranged on a document 18, is illuminated by a light source 7 (sun, lamp) at an angle of incidence β relative to the surface. A volume hologram formed in the security element 1 is visible at an angle of emergence γ relative to the surface. In the general case, an observer 8 (person or camera) is at an observation angle α and a distance d relative to the surface of the document. If the observation angle α and the angle of reflection γ differ, as represented in FIG. 33, the volume hologram is not visible to the observer 8.

FIG. 34 is an example representation which shows at what observation angles a volume hologram is visible. The x-axis of the diagram represented in FIG. 34 denotes the angle of reflection γ at which the volume hologram is visible. The y-axis of the diagram denotes the intensity I of the light emerging at the angle of reflection γ.

In the case represented the volume hologram is visible at three different observation angles, which correspond to the three angles of reflection γ₁, γ₂ and γ₃. In the case of different observation angles the volume hologram appears in different colors. The volume hologram appears in a first color F1, for example in green, at the angle of reflection γ₁, in a second color F2, for example in red, at the angle of reflection γ₂, and in a third color F3, for example in turquoise, at the angle of reflection γ₃. It is also possible that the colors F1, F2 and F3 are the same or almost the same. The angles of reflection γ have a tolerance range Δγ, in which the volume hologram is visible. The tolerance range Δγ is formed symmetrical around the mean value of the angle of reflection γ in the embodiment example represented in FIG. 34. The tolerance range Δγ can be, for example, ±10° or only ±5° or also only ±2° around the mean value of the angle of reflection γ.

The intensity, and thus the visibility, of the respective volume hologram is reproduced in FIG. 34 by the height of the color curves. In the embodiment example the first color F1 is the most clearly visible, while the second color F2 and the third color F3 are less clearly visible.

The respective angles of reflection γ and the colors F and intensities I of the volume hologram are determined in particular through the diffraction behavior of the volume hologram master, in particular through its surface relief and/or the grating period and/or the azimuthal angle and/or the structural depth and/or the thickness of the volume hologram layer and/or the refractive index of the volume hologram material and/or the hardening process and/or through the parameters of the exposure, above all through the exposure wavelength and/or the exposure intensity of the laser radiation and/or the UV radiation and/or through the exposure angle and/or through polarization and/or an optional treatment of the volume hologram material to shrink or swell the volume hologram layer.

For the production of multi-colored volume holograms it is possible, for example, to shrink or swell the volume hologram layer in areas by different hardening processes and/or different after treatments, and thus to generate areas in which the volume hologram of the volume hologram layer shows a different color F.

One or more lasers, preferably two lasers, are used for the exposure of the volume hologram layer. Here, it is possible, firstly, that the volume hologram layer is exposed by the light beams generated by the respective lasers at different angles of incidence, with the result that each of the lasers generates an image area of the volume hologram which has a different color value. Further it is also possible that the lasers emit light with different wavelengths and thus image areas with different color values are recorded in the volume hologram layer by the respective lasers.

For example, it is possible to choose these parameters such that the volume hologram appears only in an angle range of +/−10°, preferably +/−5° around a single angle γ₁ and with a single color F1 or in a narrowly limited color spectrum, but with comparatively high intensity, as represented in FIG. 35.

FIG. 36 shows the case in which the angle of reflection γ is smaller than 90°. In this case the volume hologram is visible to the observer 8 when the document 18 is tilted away from the observer 8 and when the observation angle α and the angle of reflection γ are of the same or a similar size.

FIG. 37 shows the case in which the angle of reflection γ is greater than 90°. In this case the volume hologram is visible to the observer 8 when the document 18 is tilted towards the observer 8 and when the observation angle α and the angle of reflection γ are of the same or a similar size.

FIG. 38 shows the usual manner of observation, in which the observer 8 looks at the document 18 perpendicularly and therefore the observation angle α and the angle of reflection γ must lie in the region of 90° in order that the volume hologram is visible.

According to the invention the security element 1 applied to the document 18 has, as described further above, several volume hologram layers which are arranged one over another. Optionally, further layers are present as intermediate layers, which can have optical functionalities, for example color layers and/or metal layers and/or diffractive structures or matte structures over the whole surface or present in areas and/or can function as adhesive layers and/or barrier layers.

In particular in the case of metal layers as reflective layers, it is possible that the intrinsic color of the volume hologram and/or illuminated colored optically variable effects have the result that a per se silvery achromatic metal layer (e.g. aluminum) appears correspondingly colored and a particular optical effect is generated thereby.

Through a specific design of the volume hologram master, for example through variation of the structure periods and/or of the structure shapes and/or of the azimuths of the structures, it is possible to achieve a wider angle of reflection of the volume hologram.

FIG. 39 shows an embodiment example in which a first volume hologram with a first color F1 has a very large tolerance range Δγ₁, thus an angle range in which the volume hologram is visible. A very large tolerance range Δγ is larger than +/−45°, preferably larger than +/−60°. In the embodiment example represented in FIG. 39 the tolerance range Δγ₁ has a value of approximately 160°. The first volume hologram is therefore visible for almost all observation angles α between 10° and 170°. The first volume hologram is formed in a first volume hologram layer of the security element.

Preferably sinusoidal, diffractive gratings, the grating period, orientation and depth of which are designed corresponding to the desired holographic effect, for example a movement effect, are suitable as a master for the production of volume holograms with large tolerance ranges Δγ. The grating periods vary from 0.3 μm to 3.0 μm, preferably from 0.5 μm to 2.0 μm. The grating depths lie in the range from 50 nm to 400 nm, preferably in the range from 100 nm to 200 nm.

Particularly interesting optical effects, for example a very great depth or a striking movement effect, result from masters with relief structures with an optical effect similar to a macroscopically concave or convex lens or a macroscopically concave or convex freeform surface. Such masters can consist, for example, of grating structures with sinusoidal profiles. Alternatively, asymmetrical grating structures can also be used. In the case of round lenses the gratings are arranged circularly around a center. The grating periods are larger in the center of the lens and smaller at the lens edge and vary from 0.3 μm to 2500 μm, preferably from 0.8 μm to 100 μm. The grating depths lie in the range from 50 nm to 10 μm, preferably in the range from 100 nm to 5 μm.

Alternatively, instead of gratings, isotropic or anisotropic matte structures can also be used as masters. These irregularly formed structures scatter the light and likewise generate volume holograms which are visible in a very large angle range.

In contrast, a second volume hologram with a second color F2 has only a small tolerance range Δγ₂, i.e. the tolerance range Δγ₂ is smaller than +/−10°, preferably smaller than +/−5°. As a result, the second volume hologram is visible only in a correspondingly small observation angle range Δα. The second volume hologram is formed in a second volume hologram layer of the security element. The colors F1 and F2 can also be the same.

The color of a volume hologram is preferably determined by a transmission measurement. For this, a UV-Vis spectrometer is usually used. Image 40 shows a typical transmission spectrum. From this, the peak wavelength λ_{P} and the spectral bandwidth Bₛ are determined as characteristic values.

The spectral bandwidth Bₛ is defined as the bandwidth in the case of the transmittance T_{B}, wherein T_{B}=(T_{Ref}+Tₘᵢₙ)/2.

Peak wavelengths for red volume holograms lie in the range from 600 nm to 680 nm, typically at 610 nm to 620 nm, and for green volume holograms lie in the range from 520 nm to 560 nm, typically at 535 nm to 545 nm. The spectral bandwidths Bₛ are 5 nm to 20 nm, typically 10 nm.

It can advantageously be provided that the surface structures of the volume hologram master are asymmetrical surface structures. These are blazed gratings provided with a reflective surface with sawtooth-shaped surfaces, for example with a spatial frequency of from 100 lines/mm to 2000 lines/mm. It can further be provided that the blazed grating has a grating depth of from 0.1 μm to 2 μm. Blazed gratings with the above-named dimensions can be generated by thermoplastic deformation, for example using a heated embossing roller, or photomechanically by exposure of a UV-curing varnish. Generally, the gratings of the master can be a mosaic-like representation next to one another of a large number of different gratings, e.g. blazed gratings with a grating period of from approx. 500 nm to approx. 1500 nm and a grating depth between 100 nm and 600 nm with different azimuthal orientations, kinoforms, asymmetrical achromatic gratings, matte structures, relief structures with an optical effect similar to a macroscopically concave or convex lens or a macroscopically concave or convex freeform surface, etc. as well as combination structures of these.

FIG. 41 shows the structure and the mode of operation of a security element 1 according to FIG. 39 with a first volume hologram layer 13a and a second volume hologram layer 13b. A first color F1, for example green, is generated in the first volume hologram layer 13a and is visible only in a narrow angle range. A second color F2, for example red, is generated by the second volume hologram layer 13b and is visible in a large angle range.

FIG. 42 shows a volume hologram master formed as a surface relief master in cross section. In the embodiment example represented in FIG. 42 a volume hologram master 9 has a first blazed grating 91ba with a grating period of 1 μm and a grating depth of 300 nm and a second blazed grating 91bb with a grating period of 0.78 μm and a grating depth of 280 nm. The areas of surface of the volume hologram master 9 not covered with the first blazed grating 91ba or with the second blazed grating 91bb have a surface relief with a matte structure 91m which scatters incident light diffusely and therefore creates the optical impression of a “black mirror”. In addition or alternatively to the matte structure 91m, the use of a light-absorbing, high-frequency crossed grating relief structure with more than 2000 lines/mm, in particular with, for example, 3000 lines/mm, and a depth-to-width ratio of more than 0.2 is also possible. In this embodiment example the volume hologram master 9 is formed from a nickel-cobalt alloy and can be formed flat, or smooth, or curved.

The principle of the production of a volume hologram is shown in FIG. 43. A volume hologram master 9 is in contact with a carrier film 11 coated with a detachment layer 17t, a protective layer 17s, an intermediate layer 17 and a photopolymer layer 12. The volume hologram master 9 and the coated carrier film 11 are guided along in a feed direction v. In the case of a laminating film, no detachment layer 17t is provided. The photopolymer layer 12 can be applied as a viscous photopolymer layer. It can be provided to pre-cure a mobile photopolymer layer during the printing or shortly thereafter by means of UV light, with the result that the optimum viscosity for the further processing is set. For the exposure of the photopolymer layer 12 a laser is provided which emits a laser beam 71 directed onto the surface relief master 9. The angle at which the laser beam 71 strikes can be optimized by tests and can be, for example, 14° relative to the vertical.

The volume hologram master 9 can be applied to a cylinder and can therefore be used in the curved state.

FIGS. 44 to 62 show further embodiment examples of a document formed with the security element 1.

FIG. 44 shows an eleventh embodiment example of a document 18 formed with the security element 1. The security element 1 has a first volume hologram with a first motif 14a extended over the entire surface area of the security element 1 and a color F1 which is visible at many observation angles, i.e. both in the case of tilting about the longitudinal axis of the document 18 and in the case of pivoting about the transverse axis of the document 18. Preferably, for the first volume hologram, optical effects similar to a macroscopically concave or convex lens or a macroscopically concave or convex freeform surface, e.g. large individual lens structures or also repeating patterns of small lens structures or other optical effects of such freeform surfaces which visually generate a concave or convex bulging effect, are used, as these are visible from almost all observation directions.

The above-mentioned lens effects can cover the complete azimuthal range (angle range perpendicular to the plane of incidence) of observation angles (0-360°), because of the rotational symmetry of usual lens effects. In addition, a very large tilt angle range (angle range in the plane of incidence) is typically covered, as a very large grating period (e.g. 0.1 mm to 1 mm) prevails in the center of the lens and very small grating periods (e.g. 0.5 μm to 5 μm) prevail in the edge area of the lens. On the other hand, there are also a large number of other structures which are suitable for being visible from almost all observation directions. These are e.g. isotropic or anisotropic matte structures or also grids of linear or crossed grating structures (with a grid width below the resolution limit of the human eye), which cover a larger azimuthal range and a larger tilt angle range. Thus, for example, a grid with a pixel dimension of 10 μm×10 μm can be used. Thus, in a panel with the dimensions 80 μm×80 μm 64 different grating structures would be gridded in each other, which allows a wide azimuthal/tilt angle range to be covered for the visibility of the feature, wherein the pixels cannot be resolved by the naked eye.

A second volume hologram with a second motif 14b and a color F2 is formed such that it is visible only in a particular angle range or in a few discrete angle ranges. In FIG. 44 the case is described in which the second volume hologram is visible in the center position, i.e. without tilting and pivoting. The second motif 14b can be an individual image or an endless motif. In the embodiment example represented in FIG. 39 the second motif 14b is formed as an individual image. The first and the second volume holograms can be formed in the same volume hologram layer, but preferably in two different volume hologram layers.

FIG. 45 shows a twelfth embodiment example of a document 18 formed with the security element 1, which is formed like the document 18 described in FIG. 39 with the difference that the second volume hologram is formed as a 2-fold flip with a second motif 14b in a color F2 and a third motif 14c in a color F3. The second motif 14b, for example the letter “A”, appears in the case of pivoting to the left, the third motif, for example the letter “B”, appears in the case of pivoting to the right. The second motif 14b and the third motif 14c are in each case visible only in a particular, narrow angle range. In the case of tilting and in the center position, on the other hand, only the first volume hologram 14a is visible. The first and the second volume holograms can be formed in the same volume hologram layer, but preferably in two different volume hologram layers.

FIG. 46 shows a thirteenth embodiment example of a document 18 formed with the security element 1, which is formed like the document 18 described in FIG. 45 with the difference that the second motif 14b and the third motif 14c in the second volume hologram are formed such that the second motif 14b, for example the letter “A”, appears in the case of tilting of the document 18 away from the observer, and the third motif 14c, for example the letter “B”, appears in the case of tilting towards the observer. In the case of pivoting and in the center position, on the other hand, only the first motif 14a is visible. The first and the second volume holograms can be formed in the same volume hologram layer, but preferably in two different volume hologram layers.

FIG. 47 shows a fourteenth embodiment example of a document 18 formed with the security element 1, which is formed like the document 18 described in FIG. 45 with the difference that the second volume hologram is formed as a 3-fold flip with a second motif 14b in a color F2, a third motif 14c in a color F3 and a fourth motif 14d in a color F4. The second motif 14b, for example the letter “A”, appears in the case of pivoting to the left, the third motif 14c, for example the letter “B”, appears in the center position, and the fourth motif 14d, for example the letter “C”, appears in the case of pivoting to the right. The motifs 14b to 14d are in each case visible only a particular, narrow angle range. In each case only the first motif 14a is visible in the case of tilting away from the observer or towards the observer. The first and the second volume holograms can be formed in the same volume hologram layer, but preferably in two different volume hologram layers.

FIG. 48 shows a fifteenth embodiment example of a document 18 formed with the security element 1, which is formed like the document 18 described in FIG. 46 with the difference that the second motif 14b, for example the letter “A”, appears in the case of tilting of the document 18 away from the observer, the third motif 14c, for example the letter “B”, appears in the center position, and the fourth motif 14d, for example the letter “C”, appears in the case of tilting towards the observer. The motifs 14b to 14d are in each case visible only a particular, narrow angle range. In each case only the first motif 14a is visible in the case of pivoting to the left or right. The first and the second volume holograms can be formed in the same volume hologram layer, but preferably in two different volume hologram layers.

FIG. 49 shows a sixteenth embodiment example of a document 18 formed with the security element 1.

The first volume hologram is formed with a first motif 14a as a two-color volume hologram with a color F1 and a color F2. The first volume hologram is again visible at almost all observation angles, i.e. both in the case of tilting and in the case of pivoting as well as in the center position. The second volume hologram with a second motif 14b is likewise formed as a two-color volume hologram with a color F3 and a color F4. The second volume hologram is again visible only in a particular or in a few discrete angle ranges. In FIG. 49 the case is specified in which the second volume hologram is visible only in the center position. The second motif 14b can be an individual image or an endless motif. In the embodiment example represented in FIG. 49 the second motif 14b is formed as an individual image. The first and the second volume holograms can be formed in the same volume hologram layer, but preferably in two different volume hologram layers.

FIG. 50 shows a seventeenth embodiment example of a document 18 formed with the security element 1.

Both the first volume hologram with a first motif 14a and a color F1 and the second volume hologram with a second motif 14b and a color F2 are visible at almost all observation angles, i.e. both in the case of tilting and in the case of pivoting of the document 18 as well as in the center position. Preferably, for the first and second volume holograms, the above-described lens effects, e.g. large individual lens structures or also repeating patterns of small lens structures or other optical effects of such freeform surfaces which visually generate a concave or convex bulging effect, are used, as these are visible from almost all observation directions. The first and the second volume holograms can be formed in the same volume hologram layer, but preferably in two different volume hologram layers.

FIG. 51 shows an eighteenth embodiment example of a document formed with the security element 1.

A first volume hologram with a first motif 14a and a color F1 is visible only when the document 18 is pivoted to the left about its transverse axis. The first motif 14a is formed as an individual image with the letter “K”. A second volume hologram with a second motif 14b and a color F2 is visible only in the case of pivoting of the document 18 to the right. The second motif 14b is formed as an endless design with the number “100”. The two motifs 14a and 14b are in each case visible only in a particular, narrow angle range. The colors F1 and F2 can be different or identical. The first and the second volume holograms can be formed in the same volume hologram layer, but preferably in two different volume hologram layers.

FIG. 52 shows a nineteenth embodiment example of a document formed with the security element 1. The document 18 is formed like the document represented in FIG. 51 with the difference that the first motif 14a is formed as an endless design with the letter “K”. The first and the second volume holograms can be formed in the same volume hologram layer, but preferably in two different volume hologram layers.

FIG. 53 shows a twentieth embodiment example of a document formed with the security element 1. The document 18 is formed like the document represented in FIG. 51 with the difference that both the first motif 14a and the second motif 14b are formed as an individual image. The first and the second volume holograms can be formed in the same volume hologram layer, but preferably in two different volume hologram layers.

FIG. 54 shows a twenty-first embodiment example of a document formed with the security element 1. The document 18 is formed like the document represented in FIG. 51 with the difference that both motifs 14a and 14b are visible at the same time when the document 18 is observed in the center position. The colors F1 and F2 of the volume holograms are preferably chosen to be different here. The first and the second volume holograms can be formed in the same volume hologram layer, but preferably in two different volume hologram layers.

FIG. 55 shows a twenty-second embodiment example of a document formed with the security element 1. The document 18 is formed like the document represented in FIG. 54 with the difference that the first motif 14a is formed not as an individual image but as an endless design.

FIG. 56 shows a twenty-third embodiment example of a document formed with the security element 1. The document 18 is formed like the document represented in FIG. 54 with the difference that both motifs 14a and 14b are formed as an individual image.

FIG. 57 shows a twenty-fourth embodiment example of a document formed with the security element 1.

The document 18 is formed like the document represented in FIG. 51 with the difference that the first motif 14a is visible when the document 18 is observed perpendicularly in the transverse position, and that the second motif 14b is visible when the document 18 is observed perpendicularly and rotated by a particular angle, for example by 90° in FIG. 57, into the upright position. Both motifs 14a and 14b are in each case visible only in a relatively narrow rotation angle range of approximately 20°, with the result that a clear separation of the motifs is effected. The first and the second motifs can be formed in the same volume hologram layer, but preferably in two different volume hologram layers.

FIG. 58 shows a twenty-fifth embodiment example of a document formed with the security element 1.

The document 18 is formed like the document represented in FIG. 57 with the difference that the first motif 14a is formed not as an individual image but as an endless design.

FIG. 59 shows a twenty-sixth embodiment example of a document formed with the security element 1.

The document 18 is formed like the document represented in FIG. 57 with the difference that both the first motif 14a and the second motif 14b are formed as an individual image.

FIG. 60 shows a twenty-seventh embodiment example of a document formed with the security element 1.

The document 18 is formed like the document represented in FIG. 57 with the difference that the first motif 14a is visible when the document 18 is observed perpendicularly in a first transverse position, and that the second motif 14b is visible in the case of perpendicular observation and a rotation by 180° into a second transverse position. Both motifs 14a and 14b are in each case visible only in a relatively narrow rotation angle range of approximately 20°, with the result that a clear separation of the motifs is effected. The first and the second motifs can be formed in the same volume hologram layer, but preferably in two different volume hologram layers.

FIG. 61 shows a twenty-eighth embodiment example of a document formed with the security element 1.

The document 18 is formed like the document represented in FIG. 60 with the difference that the first motif 14a is formed not as an individual image but as an endless design.

FIG. 62 shows a twenty-ninth embodiment example of a document formed with the security element 1.

The document 18 is formed like the document represented in FIG. 61 with the difference that both the first motif 14a and the second motif 14b are formed as an individual image.

### LIST OF REFERENCE NUMBERS

1, 1′ security element
1f volume hologram film
2 device
3a first manufacturing station
3b second manufacturing station
4a third manufacturing station
4b fourth manufacturing station
5 fifth manufacturing station
6 sixth manufacturing station
7 light source
7l laser beam
8 observer
9 volume hologram master
11 carrier film
12 photopolymer layer
12f photopolymer film
13a first volume hologram layer
13b second volume hologram layer
13c third volume hologram layer
14a first motif
14b second motif
15 background layer
15a absorption layer
15d thin-film element
15f color layer
15fl fluorescent layer
15m mask layer
15o optically variable color layer
15p phosphorescent layer
15s microstructure layer
16 adhesive layer
17 intermediate layer
17a first intermediate layer
17b second intermediate layer
17c third intermediate layer
17d fourth intermediate layer
17s protective layer
17t detachment layer
18 document
18f window
19a spacer layer
19ra first reflective layer
19rb second reflective layer
20 metallic layer
21a first filter layer
21b second filter layer
21c third filter layer
21d fourth filter layer
22 HRI layer
31 supply roll
32 take-up roll
41 coating device
41a first coating device
41b second coating device
41v supply roll
41w pressure roller
42 exposure device
42a first exposure station
42b second exposure station
42la first laser
42lb second laser
42ma first optics and first modulator
42mb second optics and second modulator
42u UV light source
42w exposure roller
43 curing device
43a first curing device
43b second curing device
91ba first blazed grating
91bb second blazed grating
91m matte structure
aₗ longitudinal axis
a_{q} transverse axis
A, B, C volume hologram
Bₛ spectral bandwidth
F1 to Fn color
I intensity
d distance
v feed direction
α observation angle
β angle of incidence
γ angle of reflection
Δγ tolerance range of the angle of reflection
λ wavelength
λ1 first wavelength
λ2 second wavelength
λ3 third wavelength
λP peak wavelength

1. A method for forming a volume hologram film having security elements which are formed as a transfer section of the volume hologram film, wherein the volume hologram film has n volume hologram layers arranged one over another, wherein the production of the volume hologram film is carried out in a roll-to-roll method with the following method steps:
a) providing a carrier film from a supply roll;
b) applying an i-th photopolymer layer to the carrier film;
c) forming an i-th volume hologram in the photopolymer layer;
d) forming an i-th volume hologram layer by curing the i-th photopolymer layer (12);
e) repeating process steps b) to d) n−1 times.

2. The method according to claim 1, wherein, in method step b), the photopolymer layer is applied by pressing of a photopolymer film, wherein the photopolymer film is provided on a supply roll.

3. The method according to claim 1, wherein in method step b), the photopolymer layer is applied over the whole surface or partially by printing, spraying or casting.

4. The method according to claim 1, wherein, in method step c), the formation of the i-th volume hologram is effected by a laser exposure.

5. The method according to claim 1, wherein the i-th photopolymer layer is pre-cured between method step c) and method step d) and is finally cured in method step d).

6. The method according to claim 1, wherein a background layer is applied to the n-th volume hologram layer.

7. The method according to claim 6, wherein an adhesive layer is applied to the background layer.

8. The method according to claim 1, wherein an adhesive layer is applied to the n-th volume hologram layer.

9. The method according to claim 1, wherein the volume hologram film is wound onto a take-up roll.

10. The method according to claim 1, wherein, for the formation of the volume hologram film into a transfer film, the following further method steps are carried out before method step b):
applying a separating layer;
applying a protective layer.

11. The method according to claim 1, wherein, for the formation of the volume hologram film into a laminating film, the following further method step is carried out before method step b):
applying an adhesion-promoter layer.

12. The method according to claim 1, wherein an intermediate layer is applied to the photopolymer layer after method step b).

13. The method according to claim 12, wherein the intermediate layer is formed as a barrier layer or an adhesion-promoter layer.

14. The method according to claim 12, wherein the intermediate layer is formed as a decorative layer.

15. The method according to claim 14, wherein the intermediate layer is formed as a partial reflective layer.

16. The method according to claim 1, wherein further method steps are provided before method step b):
applying a first and a second intermediate layer to the carrier film, wherein the second intermediate layer is formed as a replication layer;
molding a microstructure into the second intermediate layer;
applying a metallic layer to the microstructure;
applying a third intermediate layer.

17. The method according to claim 16, wherein the microstructure is formed as a blazed grating, a linear or crossed sinusoidal grating or an isotropic or anisotropic matte structure.

18. The method according to claim 1, wherein the background layer has a color layer made of color-constant pigments or colorants.

19. The method according to claim 1, wherein the background layer has an optically variable color layer.

20. The method according to claim 1, wherein the background layer has a thin-film element.

21. The method according to claim 20, wherein the thin-film element has a semi-transparent first reflective layer, a highly reflective second reflective layer and a transparent spacer layer arranged between the first reflective layer and the second reflective layer.

22. The method according to claim 21, wherein the spacer layer is formed with a thickness in the range from 100 nm to 1000 nm.

23. The method according to claim 1, wherein the background layer has a mask layer.

24. The method according to claim 23, wherein the mask layer is formed as a metallic layer, which is formed over the whole surface or in areas, covered by an intermediate layer.

25. The method according to claim 23, wherein the mask layer has a color layer formed in areas, a first intermediate layer, a metallic layer and a second intermediate layer.

26. The method according to claim 25, wherein the first intermediate layer is formed as a replication layer, a surface microstructure is molded into the first intermediate layer, and a metallic layer is applied to the surface microstructure.

27. The method according to claim 25, wherein the metallic layer is formed from aluminum, copper, gold, silver, chromium, tin or an alloy of these materials.

28. The method according to claim 24, wherein the metallic layer is formed with a thickness in the range from 0.1 nm to 1000 nm.

29. The method according to claim 1, wherein the background layer has an absorption layer.

30. The method according to claim 29, wherein the absorption layer is formed as a dielectric filter.

31. The method according to claim 1, wherein the background layer has a fluorescent layer.

32. The method according to claim 1, wherein the background layer has a phosphorescent layer.

33. The method according to claim 1, wherein the background layer has a microstructure layer.

34. The method according to claim 33, wherein the microstructure layer is formed as a replication layer, wherein a surface microstructure is molded into the replication layer and a metallic layer is applied to the surface microstructure.

35. The method according to claim 34, wherein the metallic layer is applied in areas.

36. The method according to claim 34, wherein the microstructure layer is formed as a replication layer, wherein a surface microstructure is molded into the replication layer and an HRI layer with a high refractive index is applied to the surface microstructure.

37. The method according to claim 36, wherein the surface microstructure is formed as a linear or crossed sinusoidal grating, as an asymmetrical blazed grating, as an isotropic or anisotropic matte structure or as a surface hologram.

38. The method according to claim 37, wherein the surface microstructure has periods in a range from 0.2 μm to 10 μm, and depths in a range from 30 nm to 5000 nm.

39. A security document having a security element, which is transferred to the security document from a volume hologram film according to claim 1.
